(19) United States
(12) Patent Application Publication
(10) Pub. No.: US 2015/0142263 A1
(43) Pub. Date: May 21, 2015

(54) IMAGING UNIT, ATTACHED MATTER DETECTOR, CONTROL SYSTEM FOR VEHICLE, AND VEHICLE

(71) Applicant: Ricoh Company, Ltd.,, Ohta-ku, Tokyo (JP)

(72) Inventors: Hideaki Hirai, Kanagawa (JP); Izumi Itoh, Tokyo (JP)

(73) Assignee: Ricoh Company, Ltd., Ohta-ku, Tokyo (JP)

(21) Appl. No.: 14/402,630

(22) PCT Filed: Jul. 8, 2013
(86) PCT No.: PCT/JP2013/069078

§ 371 Date: Nov. 20, 2014

(30) Foreign Application Priority Data
Jul. 13, 2012 (JP) 2012-157174
May 14, 2013 (JP) 2013-101851

(51) Int. Cl. G06K 9/00; H04N 5/225; B60S 1/08; G01N 21/43

(52) U.S. Cl. CPC G06K 9/00791; G01N 21/43; H04N 5/2254; B60S 1/0844
USPC 701/36; 348/148

(57) ABSTRACT

An imaging unit includes a light source placed on one surface of a light transmissive plate-like element to project a light to the one surface of the plate-like element, an imaging element to capture an image of an attached matter on the other surface of the plate-like element illuminated with the light from the light source, and an optical element having an incidence surface on which the light is incident from the light source, a reflective surface by which the light incident from the incidence surface is reflected, a transmissive surface contacting the one surface of the plate-like element, through which the light reflected by the reflective surface transmits, and an exit surface from which the light transmitting through the transmissive surface and reflected by the other surface of the plate-like element is emitted towards the imaging element.

### CROSS REFERENCE TO RELATED APPLICATION

The present application is based on and claims priority from Japanese Patent Application No. 2012-157174, filed on Jul. 13, 2012 and No. 2013-101851, filed on May 14, 2013, the disclosure of which is hereby incorporated by reference in its entirety.

### TECHNICAL FIELD

The present invention relates to an imaging unit to capture an image of an attached matter on a light transmissive plate-like element, an attached matter detector to detect an attached matter from the captured image, a control system for a vehicle to control the elements of a vehicle on the basis of a detected result of the attached matter detector, and a vehicle incorporating such a control system.

### BACKGROUND ART

Japanese Patent No. 4326999 discloses an image processing system as attached matter detector to detect droplets as raindrops and foreign matter as frost or dust on the glass surface of a vehicle, ship, and airplane or on various window glasses of a building. This system projects light from a light source mounted in a vehicle cabin to a windshield and receives the light reflected by the windshield with an imaging element to capture and analyze an image to determine whether or not a foreign matter as raindrops is attached on the windshield. Specifically, it performs edge detection on the image signals of the captured image when the light source turns on, using a Laplasian filter to generate an edge image highlighting the boundary between a raindrops image area and a non-raindrops image area. Then, it conducts generalized Hough transform on the edge image, detects circular image areas, counts the number of these areas, and converts the number into the amount of rain.

The applicant proposed an imaging unit which captures an image of an area ahead of a vehicle via a windshield and an image of raindrops on the outer surface of the windshield in Japanese Patent Application No. 2011-240848. This imaging unit is described referring to the drawings in the following.

FIG. 35A shows optical paths from a light source reflected by a raindrop Rd on a windshield and entering an imaging element 1200 when the windshield is inclined at 20 degrees while FIG. 35B shows an example of captured image data.

The imaging unit includes the imaging element 1200 and a light source 1210 and is installed near the internal surface of a windshield 1105 of a vehicle. The imaging element 1200 is fixed on a vehicle's cabin ceiling, for example, at an appropriate angle so that the optical axis P of an imaging lens of the imaging element 1200 aligns with a certain direction relative to a horizontal direction. Thus, a vehicle anterior area is properly displayed on an image area for vehicle detection 1231, as shown in FIG. 35B.

In FIG. 35A the light source 1210 is fixed on the internal surface of the windshield 1105, for example, at an appropriate angle so that light therefrom is reflected by the raindrops and imaged in an image area for attached matter detection 1232. Thus, the image of the raindrops Rd on the outer surface of the windshield 1105 is displayed properly on the image area 1232, as shown in FIG. 35B.

There are demands for downsizing of such an imaging unit, aiming for reducing an installation space. However, this imaging unit including the imaging element 1200 and light source 1210 cannot satisfy the demands since the light source 1210 is fixed on the inner surface of the windshield with a distance from the imaging element 1200 to allow the light projected from the light source 1210 and reflected by raindrops to be incident on the imaging element 1200.

### DISCLOSURE OF THE INVENTION

An object of the present invention is to provide an imaging unit which captures an image of an attached matter as raindrops on a plate-like element as the outer surface of a windshield and can be easily reduced in size, as well as to provide a control system for a vehicle and a vehicle both incorporating such an imaging unit.

According to one aspect of the present invention, an imaging unit comprises a light source placed on one surface of a light transmissive plate-like element to project a light to the one surface of the plate-like element, an imaging element to capture an image of an attached matter on the other surface of the plate-like element illuminated with the light from the light source, and an optical element having an incidence surface on which the light is incident from the light source, a reflective surface by which the light incident from the incidence surface is reflected, a transmissive surface contacting the one surface of the plate-like element, through which the light reflected by the reflective surface transmits, and an exit surface from which the light transmitting through the transmissive surface and reflected by the other surface of the plate-like element is emitted towards the imaging element.

### BRIEF DESCRIPTION OF THE DRAWINGS

Features, embodiments, and advantages of the present invention will become apparent from the following detailed description with reference to the accompanying drawings:

FIG. 1 schematically shows the structure of an in-vehicle control system;

FIG. 2 schematically shows the structure of an attached matter detecting device including an imaging unit;

FIG. 3 shows the optical system of the imaging unit in FIG. 2;

FIG. 4 schematically shows one example of the structure of a light source of the imaging unit;

FIG. 5 shows another example of the structure of the light source of the imaging unit;

FIG. 6 schematically shows still another example of the structure of the light source of the imaging unit;

FIG. 7 shows an example of an optical shield provided between the light source and an imaging lens;

FIG. 8 is a schematic perspective view of the imaging unit;

FIG. 9A is a side view of the imaging unit when mounted on the windshield of a vehicle at the inclination angle of 22 degrees relative to a horizontal plane, and FIGS. 9B, 9C show the optical system of the imaging unit in FIG. 9A when no raindrop is attached and when a raindrop is attached, respectively;

FIG. 10A a side view of the imaging unit when mounted on the windshield of a vehicle at the inclination angle of 34 degrees relative to a horizontal plane and FIG. 10B shows the optical system of the imaging unit in FIG. 10A;

FIG. 11 is a perspective view of a tapered rod lens and an optical waveguide of the light source of the imaging unit;

FIG. 12 is a perspective view of a reflection/deflection prism of the imaging unit by way of example;

FIG. 13 is a perspective view of another example of a reflection/deflection prism of the imaging unit;

FIG. 14 is a perspective view of still another example of a reflection/deflection prism of the imaging unit;

FIG. 15 shows the optical system of the imaging unit using the reflection/deflection prism;

FIG. 16 is a graph showing a filter characteristic of a cutoff filter applicable to image data used for attached matter detection;

FIG. 17 is a graph showing a filter characteristic of a bandpass filter applicable to image data used for attached matter detection;

FIG. 18 is a front view of an optical filter of the imaging unit including a filter area for vehicle detection and a filter area for attached matter detection;

FIG. 19 shows an example of captured image data;

FIG. 20 is an enlarged view of the optical filter and an image sensor as seen from a direction orthogonal to an optical transmissive direction;

FIG. 21 shows a relation between filter areas for vehicle detection and attached mater detection and image areas for vehicle detection and attached mater detection on the image sensor;

FIG. 22 is a graph showing a transmittance characteristic of a first spectral filter of the optical filter;

FIG. 23 is an enlarged view of a wire grid polarizer of the optical filter as a polarization filter;

FIG. 24 is a graph showing a transmittance characteristic of a second spectral filter of the optical filter;

FIG. 25A shows an example of an image in which some raindrops attached (no fog) are captured, using the reflection/deflection prism in FIG. 14 and FIG. 25B shows the same in which both fog and raindrops attached are captured;

FIG. 26A shows an example of an image captured for detection of raindrops when the light source is turned off while FIG. 26B shows the same when the light source is turned on;

FIG. 27 is a flowchart for detecting the attached matter on the windshield;

FIG. 28 is a flowchart for detecting wiper control parameter or defroster control parameter from image data in the image area for vehicle detection;

FIG. 29 shows an image of a fogged windshield;

FIG. 30 shows an image of a frozen windshield;

FIG. 31 is a flowchart for detecting wiper control parameter or defroster control parameter from image data in the image area for attached matter detection;

FIG. 32 is a flowchart for determining the state of the windshield;

FIG. 33 shows a table as a reference for the determining process in FIG. 32;

FIG. 34 is a table containing instructions for the results of the determining process in FIG. 32;

FIG. 35A shows the optical paths from the light source reflected by raindrops to the imaging element when a related art imaging unit is mounted on the windshield at inclination angle of 20 degrees and FIG. 35B shows an example of image data captured by the imaging unit;

FIG. 36 shows the optical paths from the light source reflected by the outer surface of the windshield when the imaging unit optimized for a window shield inclined at 20 degrees is installed on a windshield inclined at 20 degrees;

FIG. 37 shows the optical paths from the light source reflected by the outer surface of the windshield when the imaging unit optimized for a windshield inclined at 20 degrees is installed on the windshield inclined at 35 degrees;

FIG. 38 is a graph showing the light receiving amounts of the imaging element relative to light reflected by raindrops and light reflected by the windshield when specular reflection by the outer surface of the windshield is not incident on the imaging element; and

FIG. 39 is a graph showing the same as in FIG. 38 when specular reflection by the outer surface of the windshield is incident on the imaging element.

### DESCRIPTION OF EMBODIMENTS

Hereinafter, embodiments of an in-vehicle control system incorporating an imaging unit to which the present invention is applied will be described in detail with reference to the accompanying drawings. Wherever possible, the same reference numbers will be used throughout the drawings to refer to the same or like parts. In addition to the in-vehicle control system, the imaging unit is applicable to other systems which use an attached matter detector to detect matter on a light transmissive plate-like element according to a captured image, for example.

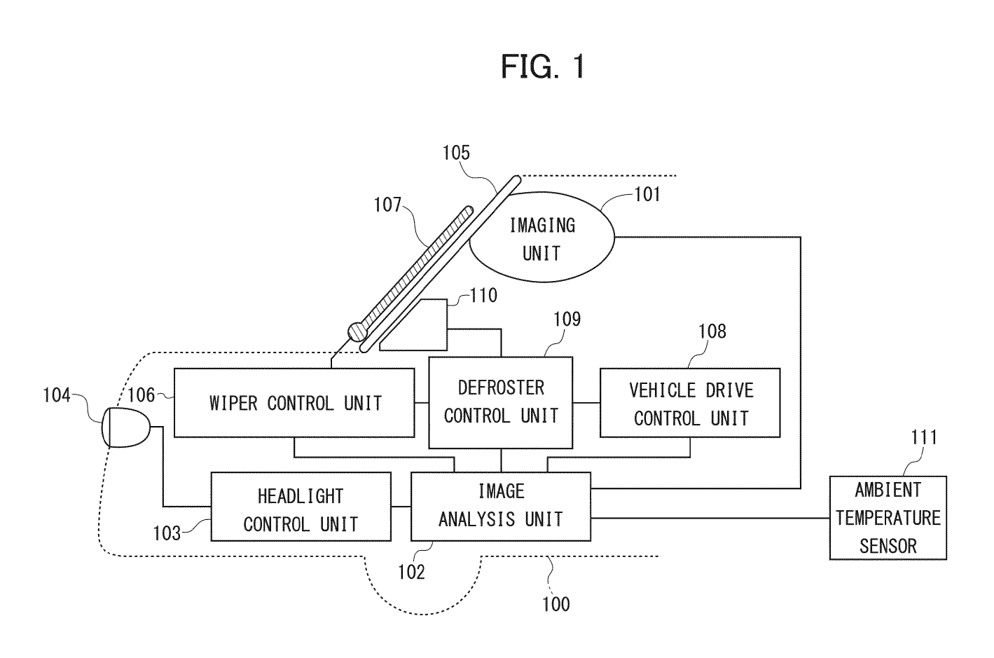

FIG. 1 schematically shows the structure of an in-vehicle control system according to one embodiment which controls the light distribution of headlights and the operation of windshield wipers and other in-vehicle units, using image data in a vehicle anterior area as an imaging area captured by the imaging unit of a vehicle 100 as automobile.

The in-vehicle control system includes an imaging unit 101 which is mounted close to a not-shown rearview reflective mirror on a windshield 105, for example, to capture an image of a vehicle anterior area in the traveling direction of the vehicle 100. The image data captured by the imaging element of the imaging unit 101 is input to an image analysis unit 102 to analyze the image data, calculate the position, direction, and distance of other vehicles ahead of the vehicle 100, or detect foreign matter such as raindrops attached on the windshield 105 or target objects such as the end of a road, white road markings in the imaging area.

The vehicle 100 includes an ambient temperature sensor 111. The image analysis unit 102 performs a variety of detection as above using detected results of the ambient temperature sensor 111. For example, it is configured to detect a frost on the windshield 105 from the results from the ambient temperature sensor 111 according to the present embodiment.

The calculation results of the image analysis unit 102 are transmitted to a headlight control unit 103. Specifically, the headlight control unit 103 controls the headlights 104 to switch between a high beam and a low beam, or partially shades them, for example, to avoid a bright light of the headlights 104 from entering the eyes of a driver of a preceding or oncoming vehicle and maintain a good view of the driver of the vehicle 100.

The calculation results are also sent to a wiper control unit 106 to control a windshield wiper 107 to remove raindrops and foreign matter attached on the windshield 105. It generates a control signal for the windshield wiper 107 in response to a result of detected foreign matter by the image analysis unit 102. Receiving the control signal from the wiper control unit 106, the windshield wiper 107 operates to clear the driver's view.

The calculation results are also sent to a vehicle drive control unit 108. The vehicle drive control unit 108 issues a warning to a vehicle's driver and controls a steering wheel or a brake for driving assist on the basis of a detected road end or a white marking when the vehicle 100 is running off from a traffic lane.

The vehicle drive control unit 108 compares information about a road sign and a driving state of the vehicle on the basis of a road sign detected by the image analysis unit 102. It issues a warning to the driver of the vehicle 100 when the drive speed of the vehicle 100 is approaching a speed limit indicated by a detected road sign or controls a brake when the driving speed of the vehicle is exceeding the speed limit.

The calculation results of the image analysis unit 102 are also transmitted to a defroster control unit 109 which generates a control signal for a defroster 110 according to a detected frost or fog on the windshield 105. The defroster 110 blows air to the windshield 105 or heat the windshield 105 to remove the frost or fog upon receipt of the control signal from the defroster control unit 109. The defroster control will be described in detail later.

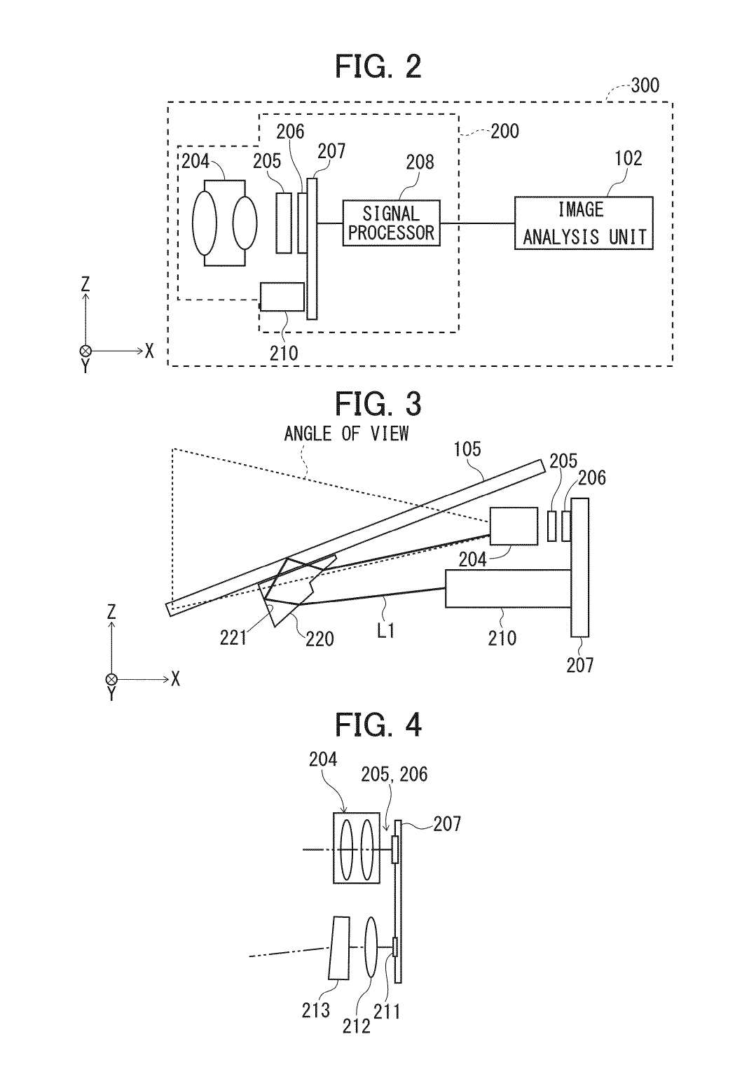

FIG. 2 schematically shows the structure of an attached matter detector 300 comprising the imaging unit 101 having an imaging element 200. The imaging element 200 comprises an imaging lens 204, an optical filter 205, a substrate 207 on which an image sensor 206 having two-dimensional pixel arrays is mounted, and a signal processor 208 to generate image data by converting an analog electric signal (light receiving amount of the pixels on the image sensor 206) from the substrate 207 to a digital electric signal. In the present embodiment a light source 201 is mounted on the substrate 207 to detect attached matters on the outer surface of the windshield 105 as the other surface. In the following raindrops are mainly described as an example of attached matter.

In the present embodiment the imaging unit 101 is disposed so that the optical axis of the imaging lens 204 aligns with a horizontal direction as X axis in FIG. 2. Alternatively, the optical axis thereof can be oriented in a specific direction relative to a horizontal direction. The imaging lens 204 is for example made up of lenses having a focal point far from the windshield 105. For example, the focal position of the imaging lens 204 can be set to infinite or somewhere between infinite and the windshield 105.

The optical filter 205 is placed behind the imaging lens 204 to limit the wavelength band of light incident on the image sensor 206. In the present embodiment the optical filter 205 reduces the influence from ambient light from the outside of the vehicle for determining the status of the windshield from the light projected from the light source 210 and reflected by the windshield 105. The optical filter 205 is omissible if the state of the windshield 105 is accurately detected.

The image sensor 206 comprises two-dimensionally arranged light receiving elements or pixels which receive the light having transmitted from the optical filter 205. Each pixel photoelectrically converts an incident light. Although not shown in detail in the drawings, the image sensor 206 comprises several hundred thousands of pixels and can be a CCD (Charge Coupled Device) or CMOS (Complementary Metal Oxide Semiconductor), for instance.

The signal processor 208 is electrically connected with the image analysis unit 102 to convert an analog electric signal from the substrate 207 to a digital electric signal to generate image data. The signal processor 208 generates a digital signal or image data representing brightness of each pixel of the image sensor 206, upon receiving the analog signal via the substrate 207, and outputs it to the image analysis unit 102 together with horizontal and vertical synchronous signals.

The image analysis unit 102 comprises various functions. It controls the imaging operation of the imaging unit 101 and analyzes image data from the imaging unit 101. It also calculates and sets optimal exposure amount (exposure time in the present embodiment) for a captured object such as another vehicle ahead of the vehicle 100, raindrops, frosts, or fog on the windshield 105, and adjust the timing at which the light source 210 projects a light beam along with the exposure adjustment. Further, from the image data from the imaging unit 101, it acquires information about a road condition or road sign or a current state (raindrops, frosts, or fog) of the windshield 105 as well as calculates a position, orientation, and distance of another vehicle ahead of the vehicle 100.

FIG. 3 shows the optical system of the imaging unit 101 according to the present embodiment. The light source 210 illuminates the windshield 105 to detect an attached matter thereon and comprises LEDs. Because of this, it can expand the area in which an attached matter is detected on the windshield 105 in comparison with a single LED and improve the accuracy at which a change in the state of the windshield 105 is detected.

The LEDs are mounted on the substrate 207 together with the image sensor 206. Separate substrates are not needed for them so that the number of substrates is reduced, leading to cost reduction. The LEDs are arranged in an array or arrays along Y axis in FIG. 3 to be able to evenly illuminate the windshield 105 for capturing the image thereof below an area in which an image of a vehicle anterior area is displayed.

The light source 210 is placed on the substrate 207 such that the optical axis of the light from the light source makes a certain angle with that of the imaging lens 204 as well as that the illumination area thereof on the windshield 105 is to be within an angle of view of the imaging lens 204. The light source 210 can be one or more LEDs or semiconductor lasers (LD). For the purpose of protecting the eyes of a driver of an oncoming vehicle or a pedestrian, the optical wavelength of the light source 210 should not be of a visible light and preferably longer than that, for example, about 800 to 1,000 nm in a range of infrared light wavelength, which the light receiving sensitivity of the image sensor 206 can cover. The timing at which the light source 210 emits light is controlled through the image analysis unit 102 in coordination with an image signal from the signal processor 208.

The light reflected by the windshield 105 changes depending on the condition of the windshield 105 such as frosted raindrops or night dew on the outer surface or fogging on the inner surface caused by moisture. The change in the reflected light can be acquired by analyzing an image captured with the image sensor 206 via the optical filter 205.

Aligning the optical axis of the LEDs 211 of the imaging element 200 and the normal line on the image sensor 206 to be along a normal line relative to the substrate surface can simplify the manufacture process. However, in the present embodiment the light emission of the light source and the imaging of the imaging element 200 or the optical axis of the imaging lens are in different directions. Therefore, it is difficult to provide the LEDs 211 and the image sensor 206 on the same substrate 207.

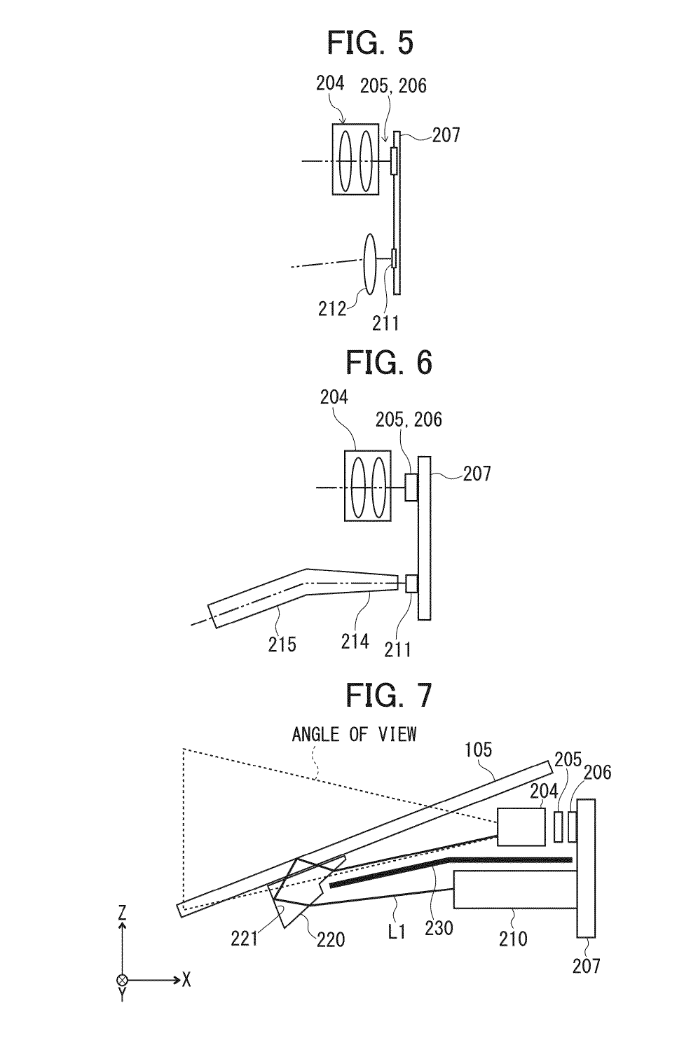

To mount the LED 211 and the image sensor 206 on the same substrate, for example, an element to change an optical path of the LEDs 211 such as a deflection prism 213 in FIG. 4 or collimate lenses 212 eccentrically arranged in FIG. 5 can be provided in the light source 210. The number of collimate lenses 212 has to be equal to the number of LEDs 211 and a lens array along Y axis can be used.

Alternatively, the element can be a tapered optical guide 215 as shown in FIG. 6. The tapered optical guide 215 is provided near the exit side of the LEDs 211 on the substrate 207 to allow the light from the LEDs 211 to be reflected by the inner surface of the optical guide 215 while passing therethrough and emitted at an angle almost parallel to the optical axis of the LEDs 211. Thus, with the optical guide 215, an emission angle distribution can be narrowed. Further, the exit side of the optical guide 215 is configured to emit light in a desired direction. In FIG. 6 the optical guide 215 can evenly project light to a desired direction with a narrow luminance distribution. It contributes to accurately detecting the state of the outer surface of the windshield 105 and reducing a load for correcting uneven brightness.

Further, the light source 210 and image sensor 206 can be mounted on different substrates instead of the same substrate 207.

Moreover, the imaging unit 101 in FIG. 3 further comprises a reflection/deflection prism 220 having a reflective surface 221 and closely attached to the inner surface (one surface) of the windshield 105 to guide the light from the light source 210 to inside the windshield 105. Specifically, the prism 220 is fixed at one surface on the inner surface of the windshield 105 so that among specular reflection by the reflective surface 221, specular reflection by a non-attached matter area of the outer surface of the windshield 105 is properly received on the image sensor 206 irrespective of a change in the incidence angle of the light on the reflection/deflection prism 220.

To attach the reflection/deflection prism 220 on the inner surface of the windshield 105, preferably, a filler such as jell or sealing agent made from a translucent material is interposed therebetween to enhance cohesion. This makes it possible to prevent the occurrence of an air layer or air bubbles between the reflection/deflection prism 220 and windshield 105, which causes the windshield 105 to be fogged. The refraction index of the filler should be preferably an intermediate refraction index between the reflection/deflection prism 220 and windshield 105. Thus, optical loss by Fresnel reflection between the filler and reflection/deflection prism 220 and between the filler and windshield 105 can be reduced. Herein, Fresnel reflection refers to reflection occurring between materials with different refractive indexes.

The reflection/deflection prism 220 in FIG. 3 is configured to reflect the incident light from the light source 210 at the reflective surface 221 only once to the inner surface of the windshield 105. The reflected light is incident on the outer surface thereof at an angle φ (about 42≦φ≦about 62 degrees). The incidence angle φ is a critical angle at which total reflection occurs on the outer surface due to a difference in the refraction indexes of air and the outer surface of the windshield 105. Accordingly, with no attached matter on the outer surface, the reflected light by the reflective surface 221 does not transmit through the outer surface but is completely reflected thereby. The lower limit of the incidence angle φ is set to a value such that light is totally reflected by a non-attached matter area of the outer surface of the windshield 105. Meanwhile, the upper limit thereof is set to a value such that total reflection does not occur at the non-attached matter area of the outer surface.

The total reflection does not occur by the attached matter area of the outer surface of the windshield 105, on which raindrops with a refractive index 1.38 different from that 1.0 of air are attached, and light transmits therethrough. The reflected light by the non-attached matter area forms a high-brightness image portion on the image sensor 206 while that by the attached area forms a low-brightness portion due to a decrease in reflected light amount and a decrease in the light receiving amount of the image sensor 206. Thus, a contrast of the raindrops attached portion and non-attached portion appears on a captured image.

Further, an optical shield 230 can be provided between the light source 210 and imaging lens 204 as shown in FIG. 7 for the purpose of reducing the diffuse components of the light incident on the image sensor 206 to prevent a degradation of an image signal.

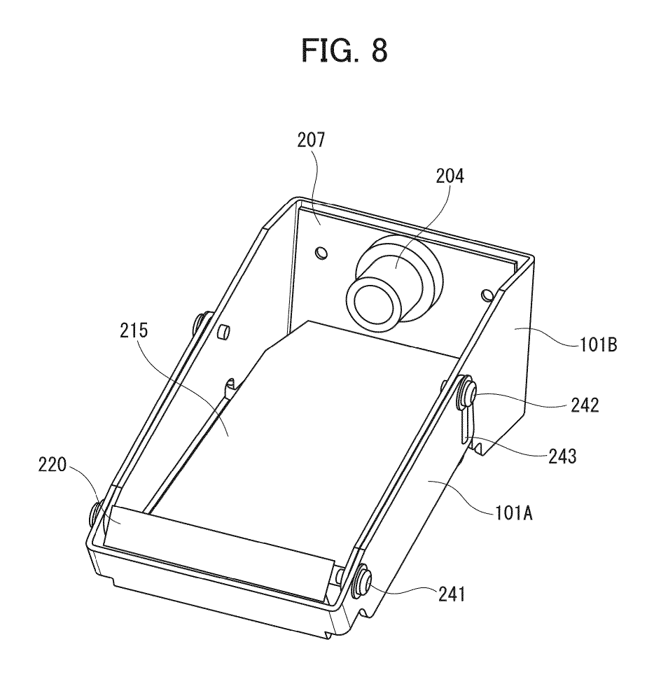

FIG. 8 is a schematic perspective view of the imaging unit 101 according to the present embodiment which uses the optical guide in FIG. 6 as an optical path changing element. The imaging unit 101 comprises a first module 101A as first support fixed on the inner surface of the windshield 105 to fixedly support the reflection/deflection prism 220 and a second module 101B as second support to fixedly support the substrate 207 on which the image sensor 206 and LEDs 211 are mounted, optical guide 215, and imaging lens 204.

The modules 101A, 101B are rotatably coupled by a rotational coupling mechanism 240 with a shaft 241 extending in a direction orthogonal to both the inclination and verticality of the windshield 105 (front and back direction in FIG. 3). The rotational coupling mechanism 240 can relatively rotate the first and second modules 101A, 101B around the shaft 241. Because of this, the first module 101A can be fixed on the windshield 105 inclined at a different angle so that the imaging element 200 in the second module 101B captures an image in a certain direction, for example, horizontal direction.

The above imaging unit 101 is installed in the vehicle 100 as follows. First, the first module 101A is fixed on the windshield 105 with one face of the reflection/deflection prism 220 closely attached on the inner surface thereof. The fixation is achieved by attaching the first module 101A on the windshield 105 with an adhesive or by engaging the first module 101A with a hook or the like provided on the windshield 105.

Next, the second module 101B is rotated about the shaft 241 of the rotational coupling mechanism 240 relative to the first module 101A. The second module 101B is fixed in the vehicle 100 at an angle adjusted so that the imaging direction of the imaging element 200 coincides with horizontal direction. Pins 242 are provided in the outer wall of the second module 101B and holes 243 are formed in the first module 101A. The pins 242 are movable within the holes 243 to limit the range of adjusting the rotation of the rotational coupling mechanism 240 or the range of adjusting the angle of the second module 101B relative to the first module 101A. The rotation adjusting range of the rotational coupling mechanism 240 is properly set in accordance with the inclination angle range of the windshield 105 which is assumed to be about 20 degrees or more 35 degrees or less herein. This inclination angle range can be arbitrary changed according to a vehicle type in which the imaging unit 101 is mounted.

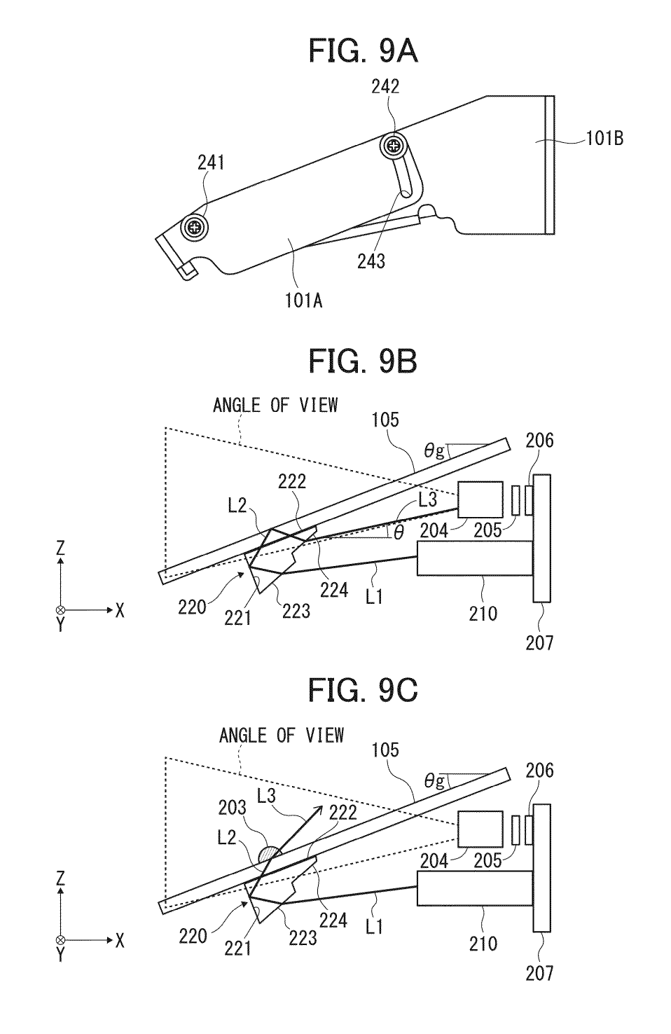

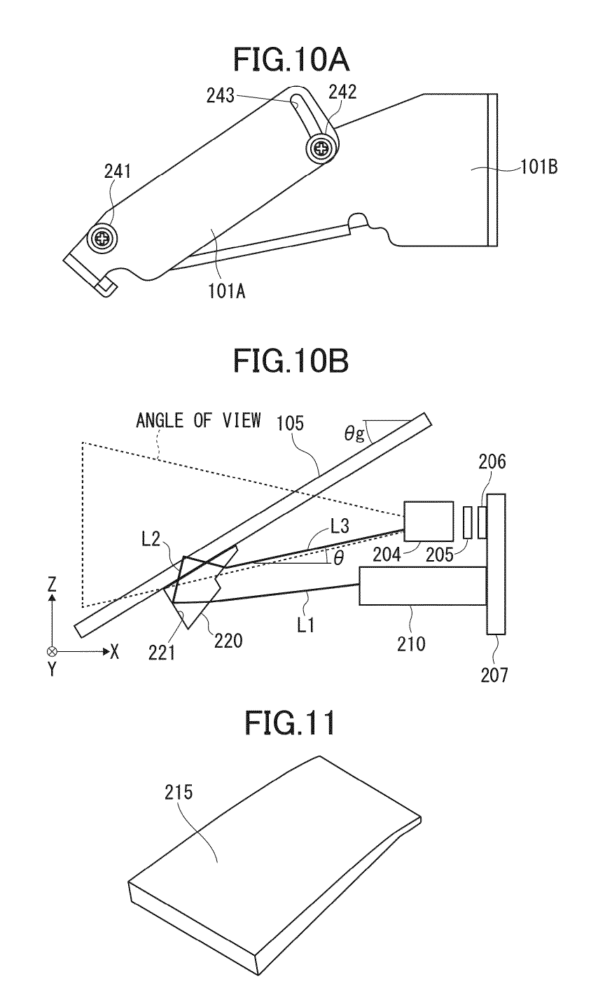

FIG. 9A is a side view of the imaging unit 101 mounted on the windshield 105 at an inclination angle θg of 22 degrees relative to a horizontal plane. FIG. 9B shows the optical system of the imaging unit 101 in FIG. 9A when raindrops are not attached on the windshield and FIG. 9C shows the same when raindrops are attached on the windshield. FIG. 10A is a side view of the imaging unit 101 mounted on the windshield 105 at an inclination angle θg of 34 degrees relative to a horizontal plane. FIG. 10B shows the optical system of the imaging unit 101 in FIG. 10A.

A light beam L1 from the light source 210 is incident on an incidence surface 223 of the reflection/deflection prism 220, refracted thereby at a certain angle, and specularly reflected by a reflective surface 221. A specular reflection L2 transmits through the inner surface 221 of the windshield 105. With no raindrops attached on the outer surface 223 of the windshield 105, the specular reflection L2 is totally reflected by the outer surface 223. A total reflection L3 transmits through the inner surface and is refracted by the exit surface 224 of the prism 220 to the imaging lens 204. Meanwhile, with raindrops attached on the outer surface of the windshield 105, the specular reflection L2 by the reflective surface 221 transmits through the outer surface. If the inclination angle θg of the windshield 105 is changed, the posture of the second module 101B on the inner surface of the windshield 105 is changed with the imaging direction kept in the horizontal direction, and the reflection/deflection prism 220 is rotated about Y axis in the drawings integrally with the windshield 105.

The reflective surface 221 of the reflection/deflection prism 220 and the outer surface of the windshield 105 are arranged so that the total reflection L3 is received in a light receiving area of the image sensor for attached mater detection in the rotation adjustment range of the rotational coupling mechanism 240. Therefore, even with a change in the inclination angle θg of the windshield 105, it is possible to properly receive the total reflection L3 in the light receiving area of the image sensor 206 and detect raindrops on the outer surface of the windshield 105.

Especially, the reflective surface 221 of the prism 220 and the outer surface of the windshield 105 are arranged to substantially satisfy the principle of a corner cube reflector within the rotation adjustment range of the rotational coupling mechanism 240. This principle refers to a phenomenon that with two reflective surfaces combined at the right angle, light is incident on one reflective surface at an angle δ, reflected by the other reflective surface and exited at the same angle δ. Specifically, the light reflected by the one surface is bent at an angle 2δ and incident on the other surface at an angle 90−δ. Since the exit angle of the light reflected by the other reflective surface is also 90−δ, the light is bent by the one reflective surface at the angle 180−2δ. In total 2δ+180−2δ=180 and the light is reflected back by the other reflective surface to the incidence direction. According to the present embodiment, using this principle, with a change in the angle θg of the windshield 105, the angle θ between the axis of the total reflection L3 by the outer surface of the windshield 105 and horizontal plane is substantially constant. Accordingly, it is possible to prevent the optical axis of the total reflection L3 from passing through a different position on the outer surface and properly detect raindrops.

The principle of the corner cube reflector holds true when the reflective surface 221 of the prism 220 and the outer surface of the windshield 105 are orthogonal. However, their arrangement should not be limited to be orthogonal. By adjusting the angle of the exit surface or incidence surface of the prism 220, the angle θ of the optical axis of the total reflection L3 to the imaging lens can be constantly maintained even with a change in the inclination angle θg of the windshield 105.

For example, if the angle between the reflective surface 221 and the outer surface of the windshield 105 is larger than 90 degrees, the angle between the exit surface 224 and the surface 222 attached to the windshield 105 is set to be larger accordingly. It is preferable to increase the angle between the exit surface 224 and surface 222 by about double the increase from 90 degrees. In this case the exit surface 224 and incidence surface 223 are not parallel so that the exit angle of the optical guide needs to be set properly in line with the exit angle of the imaging lens 204.

Further, even with the principle of the corner cube reflector satisfied, the exit position of the total reflection L3 from the reflection/deflection prism 220 is not always constant. This change in the exit position may change the position in the light receiving area of the image sensor 206 through which the optical axis of the total reflection L3 passes, which may inhibit stable detection of raindrops.

In view of this, the rotational center of the rotational coupling mechanism 240 is set to be in the rotation adjustment range to constantly receive the total reflection L3 in a predefined area on the image sensor 206, specifically, at a position in the angle of view of the imaging element 200. For example, the shaft 241 of the rotational coupling mechanism 240 is set to be located between the position on the reflective surface 221 through which the optical axis of the light beam L1 passes and the position on the outer surface of the windshield 105 through which the optical axis of the specular reflection L2 passes.

Thus, the installation of the imaging unit 101 is completed by the two steps irrespective of the inclination angle of the windshield 105, i.e., fixing the first module 101A on the windshield 105 and fixing the second module 101B at an angle adjusted so that the imaging direction coincides with the horizontal direction.

Next, FIG. 11 is a perspective view of the optical guide 215 provided close to the light source. The incidence side of the optical guide 215 can be a tapered rod lens made up of a tube-like mirror with an inner reflective surface and tapered from the incidence end to the exit end. Preferably, it is made from a material with index of refraction of 1.0 or more such as glass. It can be manufactured by molding at low costs.

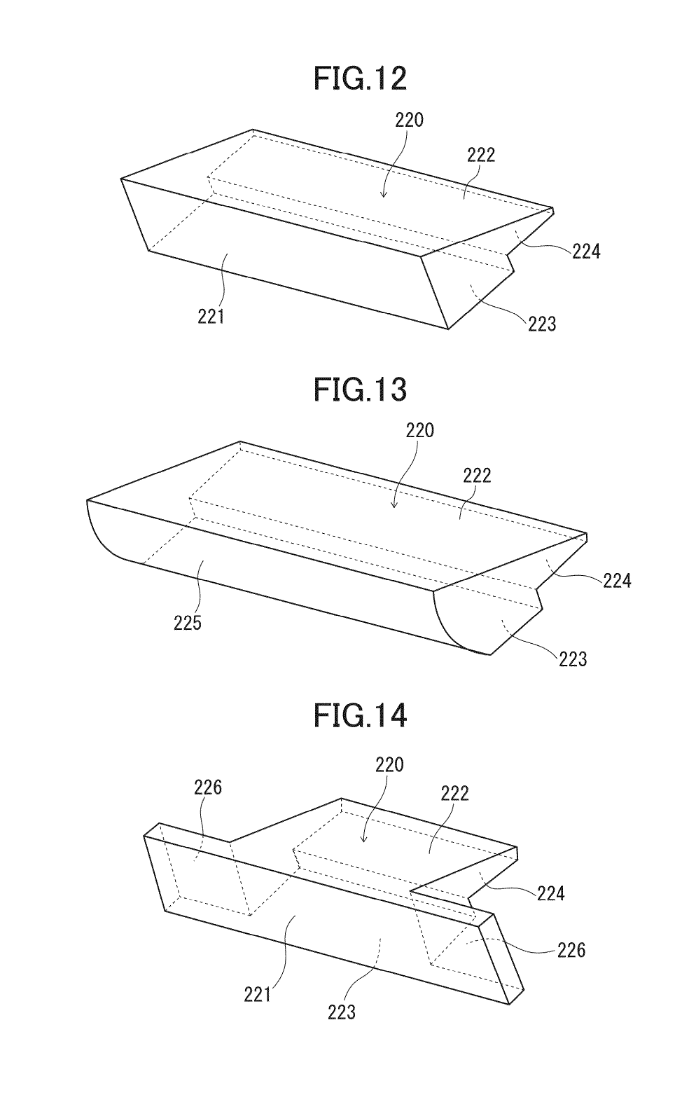

FIG. 12 is a perspective view of the reflection/deflection prism 220. It comprises the incidence surface 223 on which the light beam L1 from the light source is incident, reflective surface 221 to reflect the light beam L1, transmissive surface 222 attached on the inner surface of the windshield 105 and having the specular reflection L2 transmit therethrough, and exit surface 224 to emit the specular reflection L3 to the imaging element 200. According to the present embodiment the incidence surface 223 and exit surface 224 are parallel; however, they can be non-parallel.

The reflection/deflection prism 220 can be made from a light-transmissive material such as glass or plastic. Alternatively, it can be made from a black-color material which absorbs visible light since the light from the light source 210 is infrared light. With use of such a material, it is possible to prevent light other than the infrared light from the LEDs (visible light from outside the vehicle) from entering the reflection/deflection prism 220.

Further, the reflection/deflection prism 220 is formed to satisfy the condition for totally reflecting the light from the light source 210 by the reflective surface 221 in the rotation adjustment range of the rotational coupling mechanism 240. If that is difficult, a reflective mirror can be formed by depositing an aluminum layer on the reflective surface 221.

Further, the reflective surface 221 is planar but it can be concave as shown in FIG. 13. Such a concave reflective surface 225 can parallelize diffuse light beams, which results in preventing a decrease in the luminance on the windshield 105.

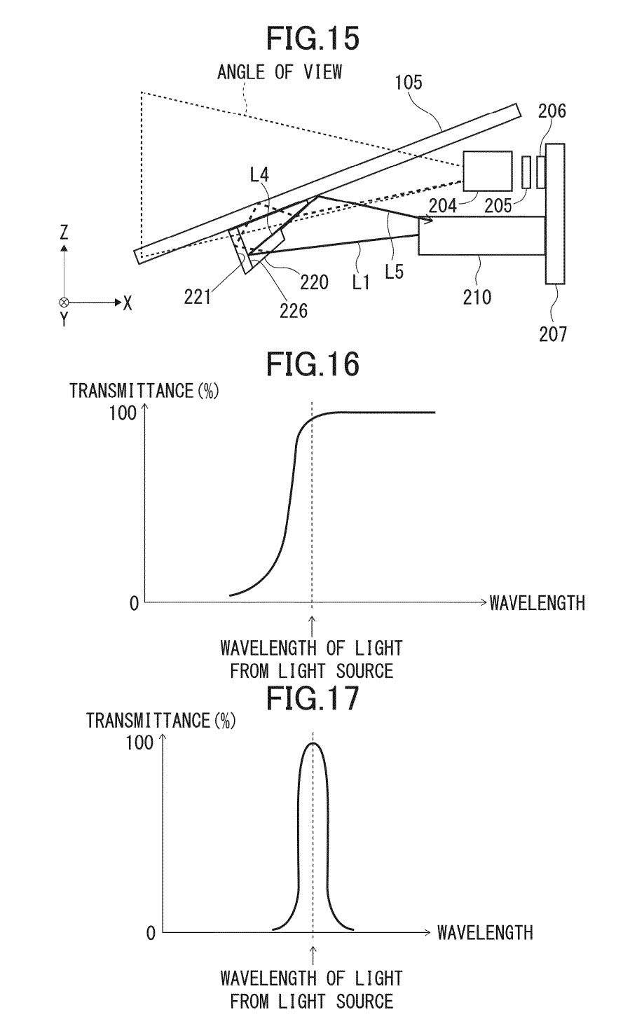

Another example of the reflection/deflection prism 220 is described with reference to FIGS. 14, 15. FIG. 15 shows the optical system of the imaging unit 101 including the reflection/deflection prism 220 in FIG. 14. This reflection/deflection prism 220 additionally includes a reflective mirror surface 206 and is intended to detect a fog on the inner surface of the windshield 105 in addition to raindrops on the outer surface, for example.

The reflection/deflection prism 220 receives, at the incidence surface 223, a center portion of the light from the optical guide 215 along Y axis and reflects it to the outer surface of the windshield 105. However, the light at both ends thereof along Y axis is not incident on the incidence surface 223 and totally reflected by the reflective mirror surface 226 to the inner surface of the windshield 105. With no fog attached thereon, a total reflection L4 is reflected by the inner surface but a specular reflection L5 is never received on the image sensor 206 in the rotation adjustment range of the rotational coupling mechanism 240.

With a fog on the inner surface, the reflection L4 is diffused by the fog and received on the image sensor 206. Thus, the occurrence of a fog on the inner surface of the windshield 105 can be detected when a certain amount or more of light is received on a portion of the image sensor 206 corresponding to the reflective mirror surface 226.

In this example the prism with the reflective surface 221 for raindrops detection and the mirror portion with the reflective mirror surface 226 for fog detection are integrated, however, they can be separated. Further, the mirror portion is provided at both sides of the prism as shown in FIG. 14 but alternatively, it can be provided only on either side of the prism or at the top or bottom of the prism.

Next, the optical filter 205 according to the present embodiment is described. To detect raindrops on the outer surface of the windshield 105, the imaging element 200 images an infrared light from the light source 210. However, a large amount of ambient light including sunlight may be incident on the image sensor 206 of the imaging element 200. To distinguish the large amount of ambient light from the infrared light from the light source 210, the light amount of the light source 210 needs to be sufficiently larger than that of ambient light, which is very difficult to realize.

In view of this, the imaging unit 200 comprises a cutoff filter to cut light with a wavelength shorter than that of the light source 210 in FIG. 16 or a bandpass filter with a peak transmittance which matches the wavelength of the light source 210 in FIG. 17 to receive the light from the light source 210 on the image sensor 206 via such a filter. Thereby, the light with a wavelength other than that of the light from the light source 200 can be removed so that the image sensor 206 receives a larger amount of light from the light source. Thus, it is possible to distinguish it from the ambient light without an increase in the light amount of the light source.

Further, in the present embodiment image data is divided into a first image area for detecting a preceding or oncoming vehicle and white line markings and a second image area for detecting attached matter as raindrops. The optical filter 205 includes a filter only for the area of the image sensor corresponding to the second image area for attached matter detection to remove light in a wavelength band other than that of the infrared light from the light source. Thus, the image sensor can receive the light in a wavelength band necessary for vehicle or white marking detection.

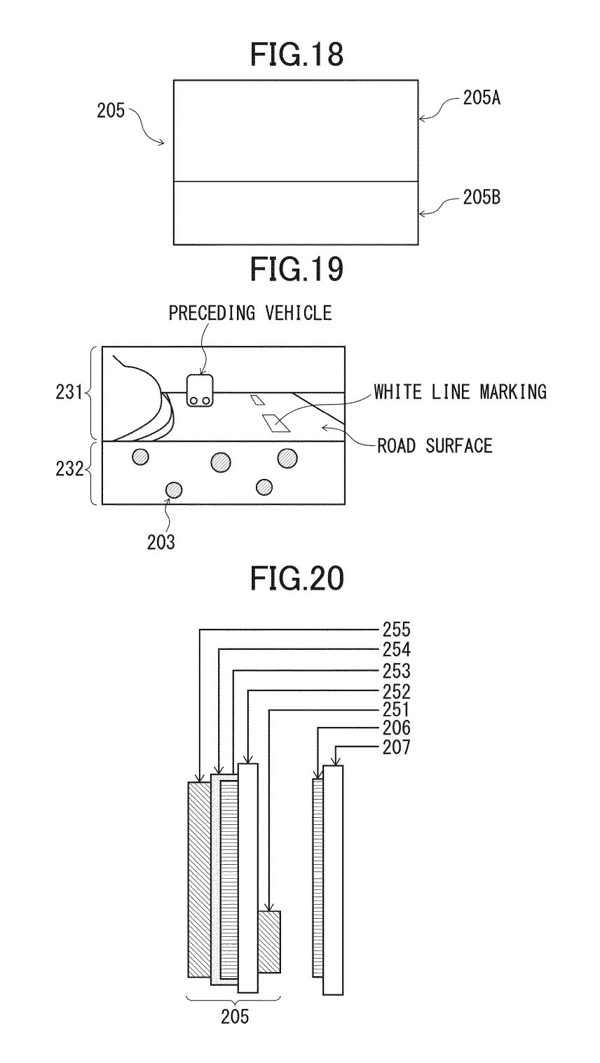

FIG. 18 is a front view of the optical filter 205 divided into two areas 205A, 205B for the first and second image areas. FIG. 19 shows an example of image data. As shown in FIG. 19, the first image area 231 is a two-thirds area at the top and the second image area 232 is a one-third area at the bottom. The headlights of an oncoming vehicle, tail lamps of a preceding vehicle, white line markings, and road signs generally appear in the upper portion of an image while a road surface ahead of the vehicle 100 and a hood thereof or a vehicle anterior area appear in the lower portion. Thus, necessary information for identifying the headlights or tail lamps and white markings is mostly in the upper portion and information about the lower portion is not very important. It is thus preferable to divide image data into the first and second image areas as above and divide the optical filter 205 into two areas in association with the two image areas, thereby detecting both the raindrops 203 and the oncoming and preceding vehicles, white line markings and road signs from the same image data.

Further, the cutoff filter in FIG. 16 and bandpass filter in FIG. 17 also serve to remove ambient light such as sunlight reflected by the hood 100a of the vehicle 100 or tail lamps of a preceding vehicle which may cause erroneous detection of the headlights and tail lamps and white line marking. Thus, the accuracy at which the headlights and tail lamps are identified can be improved.

The first and second filter areas 205A and 205B are differently configured. The first filter area 205A corresponding to the first image area 231 includes a spectral filter 251 while the second filter area 205B corresponding to the second image area 232 does not. Due to the characteristic of the imaging lens 204, the scene in the image areas and the image on the image sensor 206 are reverse. When the second image area 232 is set to the lower portion of the image, the second filter area 205B is set on the upper side of the optical filter 205.

Further, it is difficult to accurately detect the tail lamps of a preceding vehicle only from brightness data since the light amount of the tail lamps is smaller than that of the headlights of an oncoming vehicle and a large amount of ambient light as street light is present. In view of this, the optical filter 205 can additionally include a red or cyan filter through which only the light in a wavelength of the tail lamps can transmit, to be able to detect the receiving amount of red light. Thereby, it is possible to accurately identify the tail lamps on the basis of the receiving amount of red light, using spectral information.

Further, the optical filter 250 includes a spectral filter 255 to cut off light between a visible light range and a wavelength band of the light source. Thereby, it is possible to prevent the image sensor 206 from receiving light including an infrared wavelength band and generating an overall reddish image. This makes it possible to properly identify a red image portion corresponding to the tail lamps.

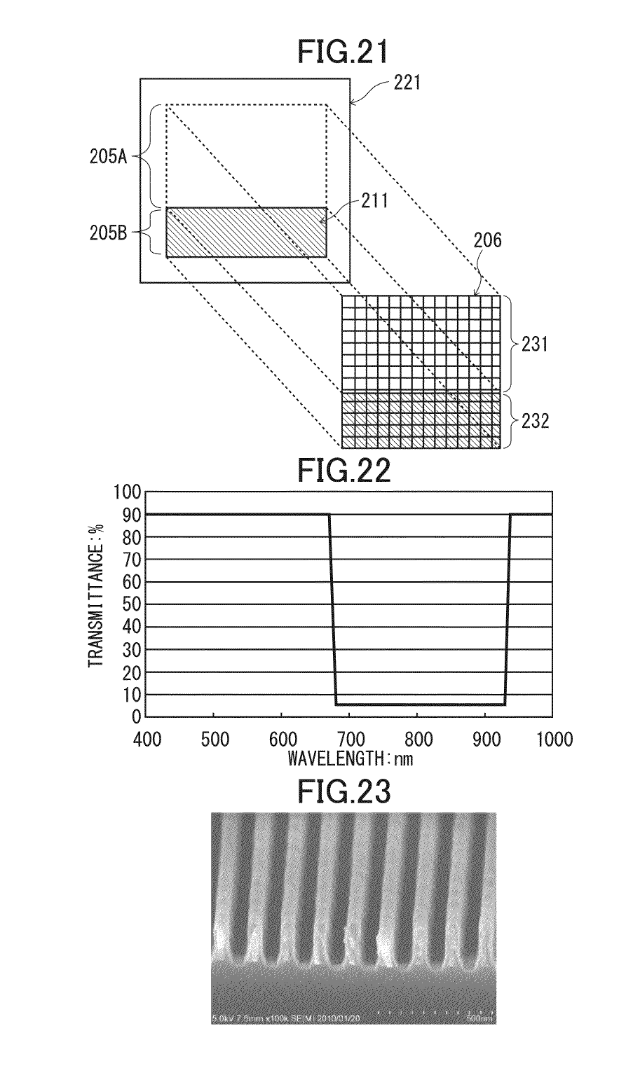

FIG. 20 is an enlarged view of the optical filter 205 and image sensor 206 as seen from a direction orthogonal to light transmission. FIG. 21 shows a relation between the first and second filter areas 205A, 205B of the optical filter 205 and the first and second image areas 231, 232 of the image sensor 206. The optical filter 205 is arranged close to the light-receiving surface of the image sensor 206. In FIG. 20 the spectral filter 255 is formed on one surface of a transparent filter substrate 252, opposing the light-receiving surface and a polarization filter 253 and the spectral filter 255 are formed on the other surface thereof. The optical filter 205 and image sensor 206 can be bonded by a UV adhesive or a quadrate area of the image sensor 206 outside an effective pixel area is bonded on the optical filter 205 by a UV adhesive or thermal compression bonding while supported by a spacer, for example.

Further, the filter substrate 252 can be made from a transparent material such as glass, sapphire, crystal through which light in visible range and infrared range is transmissible. Especially, glass, particularly, low-price, durable quartz glass with refractive index of 1.46 and tempax glass with refractive index of 1.46 are preferable in the present embodiment.

The spectral filter 255 has a transmittance characteristic as shown in FIG. 22, to transmit therethrough incident light in a visible range from a wavelength 400 nm or more to 670 nm or less and in an infrared range from a wavelength 940 nm or more and 970 nm or less and to cut off incident light in a wavelength from 670 nm or more and less than 940 nm, for example. The transmittance in the wavelength ranges from 400 nm or more to 670 nm or less and 940 nm or more and 970 nm or less is preferably 30% or more, more preferably 90% or more. The transmittance in the wavelength range from 670 nm or more to less than 940 nm is preferably 20% or less, more preferably 5% or less.

The light in a visible range is used for detecting vehicles and white line markings in the first image area 231 while that in an infrared range is used for detecting attached matter such as raindrops on the windshield in the second image area 232. The light with a wavelength of 670 nm or more and less than 940 nm is not allowed to transmit in order to prevent the overall image data from becoming reddish, which makes it difficult to extract a red portion such as a tail lamp or red sign. Accordingly, the accuracy at which tail lamps or road signs including a red portion as a stop sign in Japan are indentified can be improved.

The spectral filter 255 can be a multi-layer structure in which thin films with high refractive index and thin films with low refractive index are alternatively layered. With such a multi-layer structure, spectral transmittance can be freely set using optical interference. Even about 100% reflectance relative to a specific wavelength (other than infrared light, for example) can be realized by layering a large number of thin films.

The polarization filter 253 is provided to reduce noise due to unnecessary reflected light. The reflected light by the inner or outer surface of the windshield 105 is largely vertical polarization components (horizontal polarization components) relative to a vertical plane formed by the optical axis of the imaging lens 204 and that of the light traveling from the light source 210 to the windshield 105. Thus, the polarization filter 253 is formed to transmit the horizontal polarization components and cut off parallel polarization components (vertical polarization components) relative to the vertical plane.

The polarization filter 253 can be formed of a wire grid polarizer in FIG. 23 which is made up of conductive aluminum wires arranged in matrix with a certain pitch. With a pitch much smaller (a half or less, for instance) than the wavelength of incident light such as a visible wavelength, it can generate a single polarization by reflecting almost all the light of electric field vectors oscillating in parallel to the conductive wires and transmitting almost all the light of electric field vectors oscillating vertically to the conductive wires.

Regarding the wire grid polarizer, the larger the cross-section area of a metal wire, the larger the extinction ratio. Further, by use of a metal wire in a certain width or more relative to a cycle width, the transmittance of the polarizer decreases. A metal wire with a tapered cross section orthogonal to the length thereof exerts less wavelength dispersibility and high extinction ratio in terms of transmittance or polarization degree in a wide band. The wire grid structure can be formed by a known semiconductor process. For instance, the uneven sub wavelength structure of the wire grid can be formed by depositing, patterning, and metal etching on an aluminum film. Accordingly, the orientation of the polarizer is adjustable in unit of several microns equivalent to the pixel size of the image sensor. Further, the wire grid polarizer made from a metal as aluminum excels in high thermal resistance and is suitable for use in a vehicle.

The gaps between the filter substrate 252 and polarization filter 253 and between the convexes of the wire grid are filled with an inorganic material with refractive index equal to or lower than that of the filter substrate 252, which forms a filled layer 254. To avoid degrading the polarization characteristic of the polarization filter 253, the inorganic material is preferably one with a low refractive index as close as possible to that of air, for example, porous ceramic material as porous silica (SiO₂), porous magnesium fluoride (MgF), or porous alumina (Al₂O₃). The degree of low refractive index is determined by the porousness, i.e., the size and number of pores in ceramic. With use of a filter substrate 254 mainly made from silica crystal or glass, the filled layer 254 made from a porous silica (n=1.22 to 1.26) is preferable since its refractive index is smaller than that of the filter substrate 252.

The filled layer 254 can be formed by spin on glass process (SOG). That is, a solvent in which silanol (Si(OH)₄) is dissolved in alcohol is spin-coated on the filter substrate 252, and the solvent components are vaporized by thermal processing to initiate polymerization reaction to the silanol.

The polarization filter 253 in a wire grid structure of sub wavelength size is lower in strength than the spectral filter 255 on the filled layer 254. In the present embodiment the polarization filter 253 is covered with the filled layer 254 for protection. Thus, the wire grid structure is unlikely to be damaged when the optical filter is mounted. In addition, the filled layer 254 helps prevent foreign matter from entering the wire grid structure.

The height of the convexes of the wire grid structure is in general set to a half or less of a wavelength in use. That of the spectral filter 255 is equal to or several times larger than a wavelength in use and the larger the thickness, the sharper transmittance characteristic it exerts in a cutoff wavelength. The thickness of the filled layer 254 is preferably thin because as the thickness increases, it becomes more difficult to secure the levelness of the top surface and uniformity of a filled area. In the present embodiment the filled layer 254 can be stably formed since the spectral filter 255 is formed on the filled layer 254 after the polarization filter 253 is covered with the filler layer 254. The spectral filter 255 can also have optimal property.

In the present embodiment the spectral filter 255, filled layer 254 and polarization filter 253 are disposed on one side of the filter substrate 252 close to the imaging lens 204. In general it is important to reduce an error in the layers in manufacture process. The allowable upper limit of the error is set to be a larger value as the filters are separated further from the image sensor 206. The thickness of the filter substrate 252 is from 0.5 mm or more and 1.0 mm or less. Compared with these layers placed on the image sensor side, the manufacture process can be simplified and incurs lower costs.

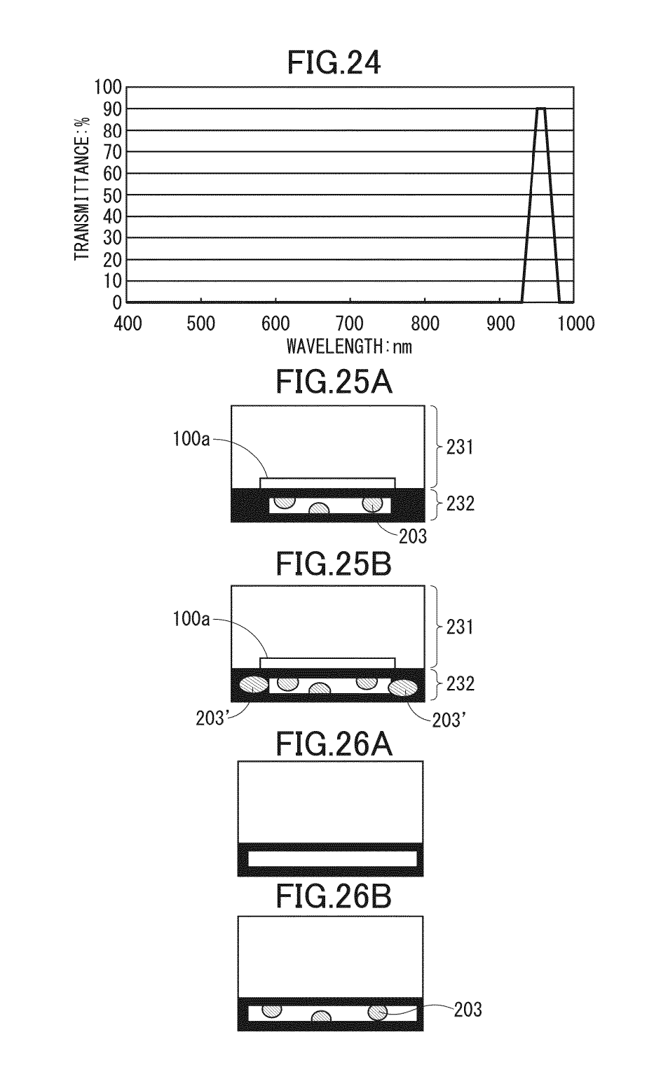

Further, the spectral filter 251 formed on the image sensor side of the filter substrate 252 is a bandpass filter with a peak transmittance which substantially matches the wavelength of the light source 210 in FIG. 24. It is provided only for the second filter area 205B to distinguish the large amount of ambient light from the infrared light projected from the light source 210 and reflected by the water drops or frosts on the windshield 105. Thereby, the light with a wavelength other than that of the light from the light source 210 can be removed, relatively increasing the amount of the light to be detected.

The optical filter 205 includes the two spectral filters 251, 255 formed on both sides of the substrate 252. This makes it possible to prevent the optical filter 205 from deflecting because stresses from both of the surfaces cancel each other out.

The spectral layer 251 is the same as the spectral filter 255 and can be a multi-layer structure in which thin films with high refractive index and thin films with low refractive index are alternatively layered, or a wavelength filter. It can be formed only for the second filter area 205B by masking the first filter area 205A while depositing multiple layers.

The spectral filters 251, 255 in a multi-layer structure can attain an arbitrary spectral radiance. A color filter used in a color sensor is made from a resist material of which spectral radiance is difficult to adjust. By use of the multi-layer structure, the transmitted wavelength band of the spectral filters 251, 255 can almost match that of the light source 201.

In the present embodiment the spectral filter 251 is provided to reduce the amount of ambient light. Without the spectral filter 251, raindrops detection is feasible. However, in view of a variation in noise, the optical filter 205 including the spectral filter 251 is more preferable.

FIG. 25A shows an example of image of raindrops attached (no fog) with use of the reflection/deflection prism in FIG. 14 and FIG. 25B shows the same of both fog and raindrops attached. Using the reflection/deflection prism 220, the horizontal center portion of the second image area 232 receives, at high brightness, the specular reflection L3 by a no raindrop area of the outer surface of the windshield 105. Meanwhile, it receives, at low brightness, a less amount of the specular reflection by raindrops 203 on the outer surface.

Both horizontal end portions of the second image area 232 never receive the specular reflection L5 from the light source 210 and are constantly at low brightness as shown in FIG. 25A. With occurrence of a fog as minute water droplets on the inner surface of the windshield 105, diffuse reflection occurs in a fog portion 203′. Upon receiving the diffuse reflection, the brightness of the end portions slightly increases from that without a fog, as shown in FIG. 25B.

The edge of the hood 100a blurs in the first image area 231 by the fog on the inner surface of the windshield 105. This phenomenon is also used for detecting presence or absence of a fog.

Even with the optical filter 205, ambient light in the same wavelength as that of the light source can transmit through the bandpass filter of the optical filter 205. Thus, ambient light cannot be completely removed. For example, in daytime sunlight includes infrared wavelength components while at night the headlights of an oncoming vehicle include infrared wavelength components. Such ambient light may cause an error in the detection of the raindrops 203. For example, by use of algorithm for detecting the presence of raindrops when a change in brightness value is over a certain amount in the second image area 232, the brightness value may be offset affected by ambient light, causing erroneous detection of raindrops.

To prevent such erroneous detection, for example, the light source 210 is controlled to turn on in synchronous with the exposure of the image sensor 206. Specifically, two images are captured at both turning-on and turning-off of the light source 210 to generate a differential image of the second image areas 232 of the two images and detect raindrops on the basis of the differential image. Therefore, at least two frames of image need to be used.

FIG. 26A shows one of the two frames captured during the turning-off of the light source 210 while FIG. 26B shows the other frame captured during the turning-on of the light source 210. In FIG. 26A only ambient light is captured in the second image area 232 and in FIG. 26B ambient light and the light from the light source 210 are captured. A brightness value or a pixel value of a differential image calculated from a brightness difference between the two frames excludes ambient light. By using the differential image, the erroneous detection of raindrops can be thus prevented. In view of decreasing power consumption, the light source 210 preferably remains turned off except for the raindrops detection.

The two frames of image from which the differential image is obtained are preferably continuous. With a temporal interval between the two frames, the amount of ambient light as the headlights of an oncoming vehicle may greatly change, which may make it impossible to cancel the ambient light in a differential image.

To control the vehicle or light distribution of the vehicle on the basis of image information on the first image area 231, automatic exposure control (AEC) is generally performed in accordance with a brightness value of an image center. For the two continuous frames, exposure control should be optimally performed in terms of raindrops detection, for example, for the same period of time. Under automatic exposure control, one of the frames captured during the turning-on of the light source 210 and the other captured during the turning-off thereof may be exposed for different periods of time. This may change a brightness value of the ambient light contained in each frame and hinder proper cancellation thereof using a differential image.

Alternatively, a difference in the exposure time can be corrected by image processing instead of the same exposure time. Specifically, a difference value Yr is calculated by the following equations:

Ya=Ya/Ta

Yb=Yb/Tb

Yr=Ya−Yb

where Ta is exposure time for the frame captured with light, Ya is a brightness value of the same, Tb is exposure time for the other frame captured with no light, and Yb is a brightness value of the same. Using a corrected differential image as above, the influence of ambient light can be properly removed even with the two frames exposed for different lengths of time.

Alternatively, the optical intensity of the light source 210 can be controlled in accordance with a difference in the exposure time. For example, the optical intensity is controlled to decrease for the frame exposed for a longer period of time. In this manner the influence of ambient light can be properly removed irrespective of a difference in the exposure time. In addition it eliminates the necessity for correcting the difference by the image processing which takes a large load.

Further, the emission of the LEDs 211 of the light source 210 varies in accordance with a temperature change. As temperature increases, the emission decreases. Further, the light amount of the LEDs 211 also decreases over time. A change in the emission of the LEDs 211 leads to a change in brightness value, which may cause erroneous detection of raindrops. In the present embodiment a determination is made on whether or not the emission of the LEDs 211 changes, and when it changes, the light source 210 is controlled to increase the emission.

The change in the emission of the LEDs 211 is determined when the overall brightness of the second image area 232 is decreased after the wiper 207 is operated. This is because with a change in the emission, the brightness of the second image area 232 is decreased since the total reflection L3 by the outer surface of the windshield 105 is captured as a two-dimensional image in the second image area 232. Meanwhile, when the outer surface of the windshield 105 gets wet from rain, the brightness of the second image area 232 is also decreased. The wiper 207 is operated to exclude a brightness decrease in the second image area due to the rain.

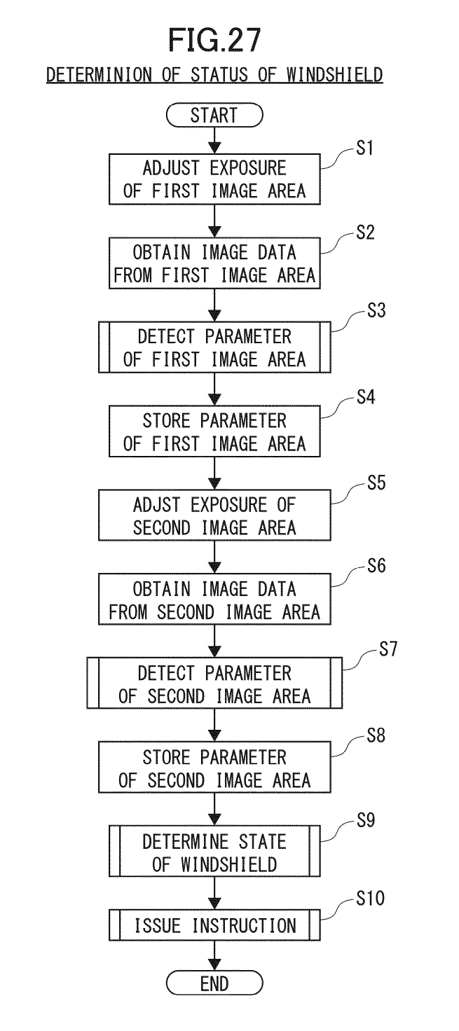

Next, a process in which the image analysis unit 102 detects the status of the windshield is described with reference to FIG. 27. The second filter area 205B for attached matter detection with the spectral filter 251 receives less amount of light than the first filter area 205A for vehicle detection with no spectral filter. There is a large difference in the amounts of light transmitting through the first and second filter areas 205A, 205B. Accordingly, the imaging condition as exposure amount for the first image area 231 corresponding to the first filter area 205A is largely different from that for the second image area 232 corresponding to the second filter area 205B.

In view of the above, different exposure amounts are applied for the first and second image areas 231, 232. For example, the exposure amount for the first image area 231 is automatically adjusted on the basis of the output of the image sensor 206. Meanwhile, that for the second image area 232 is fixed to a predetermined amount. The exposure amount is changeable by changing the exposure time. For example, the exposure time can be changed by the image analysis unit 102's controlling the time in which the image sensor 206 converts a light receiving amount into an electric signal.

The light receiving amount of the first image area 231 capturing the periphery of the vehicle 100 largely varies depending on a scene since luminance around the vehicle largely changes from several ten-thousand lux in daytime to 1.0 lux or less in nighttime. Therefore, it is preferable to adjust the exposure amount of the first image area 231 by a known automatic exposure control. Meanwhile, the light receiving amount of the second image area 232 does not change much since the light with a certain intensity from the light source 210 is received through the optical filter 205 with a known transmittance. Accordingly, the second image area 232 can be captured in a fixed exposure time without the automatic exposure control, which leads to simplifying the exposure amount control and the time taken therefor.

In step S1 the exposure of the first image area 231 is adjusted. In step S2 the analysis unit 102 acquires image data from the first image area 231. Herein, the image data in the first image area 231 is used for detecting vehicles, white line markings and road signs as well as for controlling the wiper or defroster. In step S3 the image analysis unit 102 detects parameters for the wiper and defroster controls from the image data in the first image area 231 and stores them in a predetermined memory area in step S4.

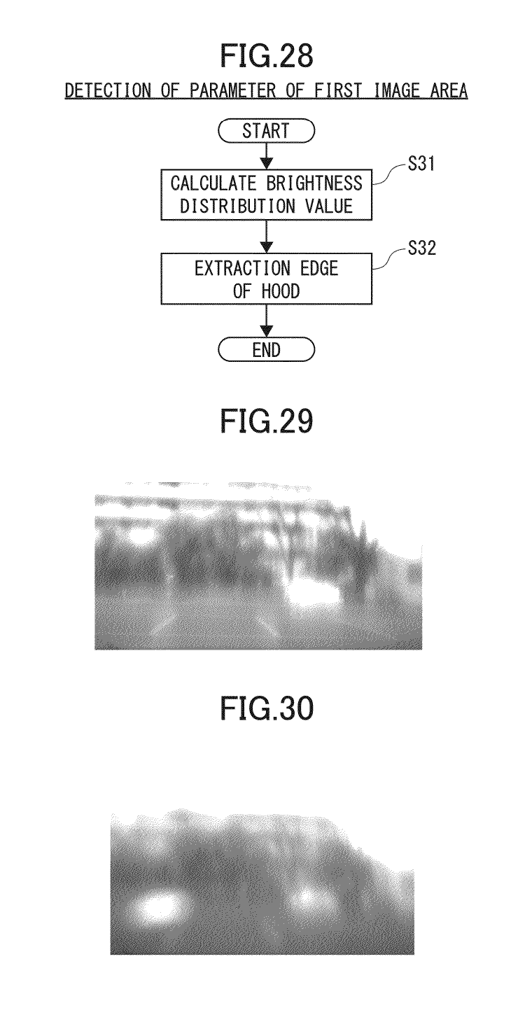

FIG. 28 is a flowchart for detecting the parameters for the wiper and defroster controls. In step S31 a brightness distribution value of the first image area 231 is detected as a parameter. In step S32 the edge portion of the hood and a background of the vehicle 100 is extracted as a parameter.

The brightness distribution value of an image of the first image area 231 is decreased if the windshield 105 is foggy as in FIG. 29 or frost as in FIG. 30, and it is difficult to extract the edge portion of the hood. Thus, these parameters are good for detecting a fog or a frost on the windshield 105.

In step S5 the exposure time for the second image area 232 is adjusted on the basis of the optical power of the light source 210 and the spectral characteristic of the spectral filter 251. In step S6 the image analysis unit 102 acquires image data from the second image area 232. In step S7 the image analysis unit 102 detects the parameters for the wiper and defroster controls from the image data of the second image area 232 and stores them in a predetermined memory area in step S8.

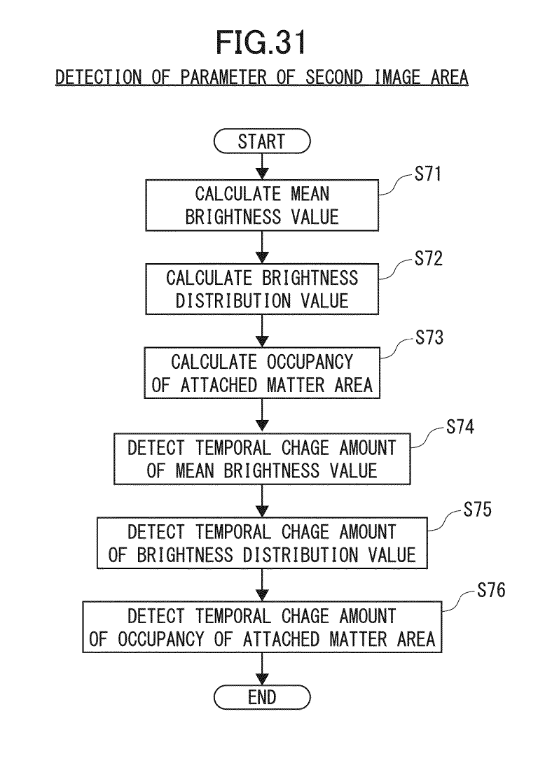

FIG. 31 is a flowchart for detecting the parameters for the wiper and defroster controls from the image data of the second image area 232. In step S71 the mean brightness value of the second image area 232 is calculated first. With raindrops, a fog, or a frost on the windshield 105, the mean brightness value of the second image area 232 is decreased. This is used for detecting attached matter on the windshield.

In step S72 the brightness distribution value of the second image area 232 is detected as a parameter. At a light rain, the total size of raindrops appearing in the second image area 232 is small so that the brightness distribution value does not change much from that at no raindrops. The brightness distribution value decreases as the amount of large-size raindrops on the windshield 105 increases because the image of raindrops blurs and overlaps. Thus, the amount of raindrops on the windshield 105 is determined as a light rain from the brightness distribution value.

In step S73 the occupancy of the attached matter area in the second image area 232 is calculated. Herein, the occupancy of the attached matter area refers to a ratio of the number of pixels (size of image) with a mean brightness value exceeding a predefined value relative to the total number (total size) of pixels of the image area 232. A fog or frost portion generally exhibits a large occupancy. Thus, it can be determined from the occupancy of the attached matter area that the attached matter on the windshield is not raindrops from a light rain but a fog or a frost.

In steps 74 to 76 the change amounts of the mean brightness value, brightness distribution value, and occupancy of the attached matter area over time are detected, respectively. The temporal change amounts signify changes in previously captured image data and currently capture image data in the second image area 232. These amounts suddenly increase in a short time due to a spray of water from another vehicle or else. Thus, it can be determined from the temporal change amounts that the attached matter on the windshield is a splash.

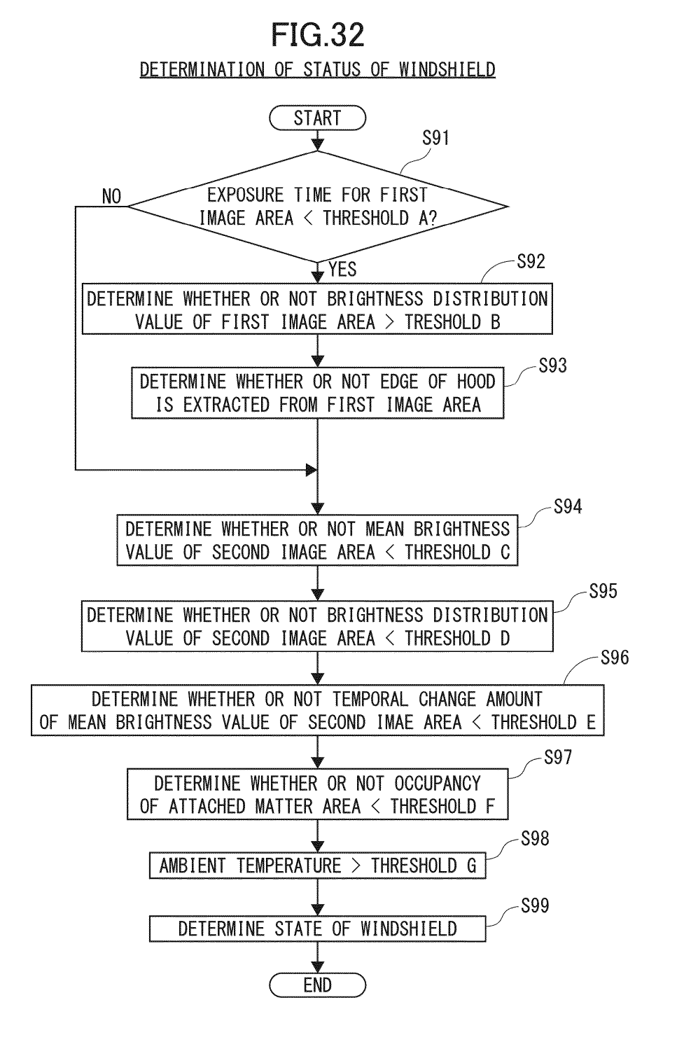

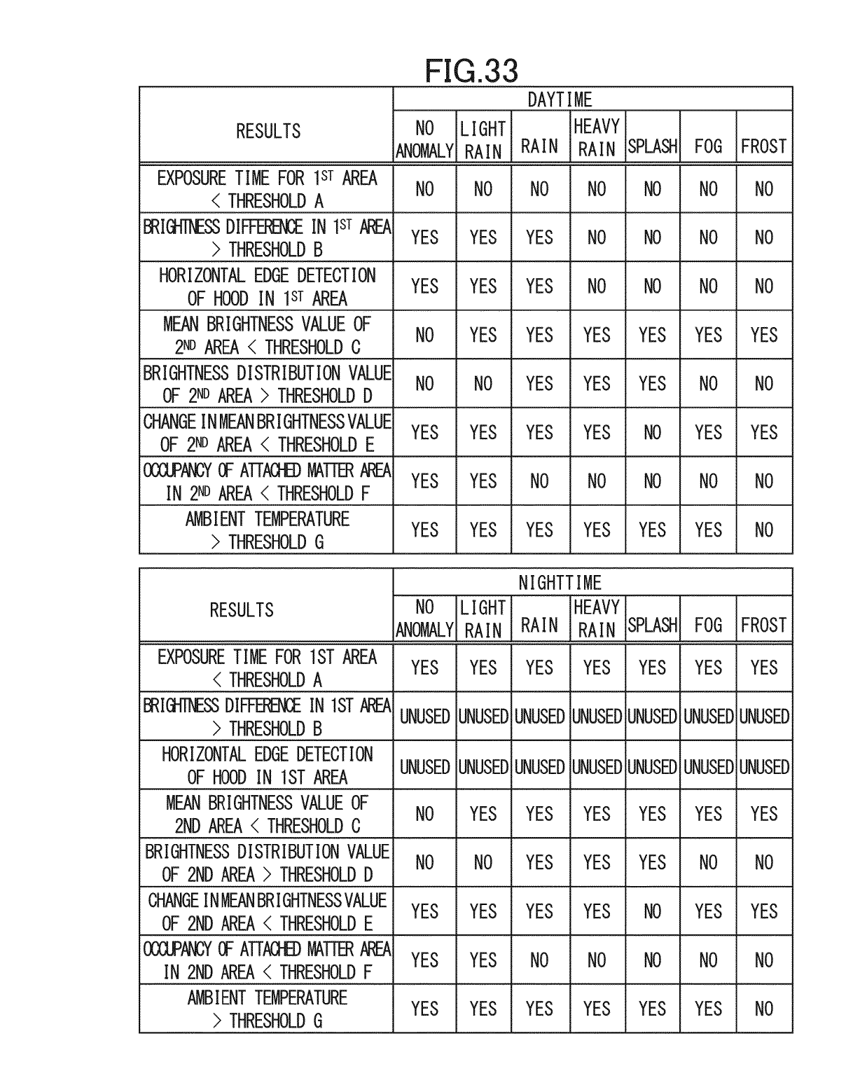

After the detected parameters are stored as above, the state of the windshield 105 is determined in step S9. The details of the determination process are described referring to FIG. 32. FIG. 33 is tables showing the criteria for the determination process. In step S91 a determination is made on whether or not the exposure time for the first image area 231 determined in step S1 is smaller than a threshold A (for example, 40 ms). A long exposure time over the threshold A signifies that the light amount of the imaging area is low and it is nighttime. Thus, nighttime or daytime can be identified from the magnitude of the exposure time relative to the threshold A.

During nighttime the state of the windshield cannot be accurately determined from the parameters as brightness distribution value and extracted edge of hood obtained from the image data of the first image area 231. With nighttime determined in step S91, therefore, only the parameters of the second image area 232 are used to determine the state of the windshield 105.

With daytime determined in step S91, a determination is made on whether or not the brightness distribution value of the first image area 231 exceeds a threshold B in step S92, and a result is stored in a predetermined memory area. It is preferable that a table including specific thresholds corresponding to exposure time obtained by experiments is prepared and the threshold B is decided in accordance with exposure time.

In step S93 a determination is made on whether or not the edge portion of the hood has been extracted, and a result is stored in a predetermined memory area. To extract the edge portion, for example, a differential image of a horizontal edge component is generated from an image area including the hood and a background according to a change in brightness of neighboring vertical pixels and compared with a pre-stored differential image by pattern matching. The extraction of the edge portion is determined when an error in the pattern matching of each portion of the differential image is a predetermined threshold or less. Based on the extraction of the edge portion, no occurrence of frost or splash on the windshield 105 can be determined.

Next, in step S94 a determination is made on whether or not the mean brightness value of the second image area 232 is smaller than a threshold C and a result is stored in a predetermined memory area. At a brightness of 1,024 tones in the second image area 232, the threshold C can be set to 900 excluding noise components, for example.

In step S95 a determination is made on whether or not the brightness distribution value of the second image area 232 is smaller than a threshold D and a result is stored in a predetermined memory area. The threshold D can be for example 50 at a brightness of 1,024 tones in the second image area 232. With the brightness distribution value smaller than 50, a fog or frost on the windshield 105 is decided.

In step S96 a determination is made on whether or not a temporal change amount of the mean brightness value of the second image area 232 is smaller than a threshold E and a result is stored in a predetermined memory area. For example, if the mean brightness value of a currently captured second image area 232 is 900 or more and that of a previously captured second image area 232 is less than 700, the occurrence of splash can be determined.

In step S97 a determination is made on whether or not the occupancy of the attached matter area in the second image area 232 is smaller than a threshold F and a result is stored in a predetermined memory area. For example, the threshold F can be set to ⅕. Under even illumination from the light source 210, when an area with the mean brightness value of less than 900 occupies below ⅕ of the second image area, a light rain is determined. At the occupancy being ⅕ or more, attached matter other than a light rain is determined.

In step S98 a determination is made on whether or not ambient temperature detected by the ambient temperature sensor 111 is larger than a threshold G and a result is stored in a predetermined memory area. The threshold G can be for example set to zero. At ambient temperature of 0 degrees the occurrence of snow or frost on the windshield is determined.

In step S99 a status of the windshield 105 is determined on the basis of the results of the above steps, referring to tables in FIG. 33. Preferably, the parameters are weighted. For example, a weighting coefficient for the parameters for the second image area 232 and ambient temperature is set to 10 while that for the parameters for the first image area 231 is set to 5. Results different from the items in “no anomaly” column of the tables are set to 1 while results the same as those are set to 0. The total sum, the results multiplied by the weighting coefficient is compared with a threshold. Thus, the status of the windshield 105 can be determined even if the results do not completely match the contents of the tables in FIG. 33.

Further, with a difference in the parameters for the second image area 232 and the contents of the no anomaly column, each parameter can be checked once again after the wiper is operated once.

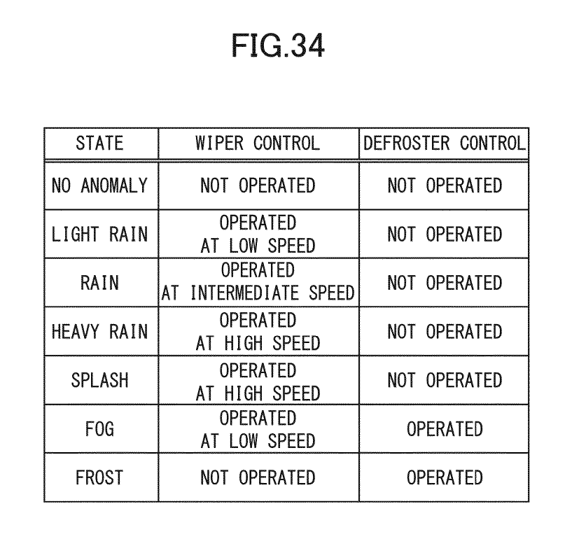

Then, in step S10 the image analysis unit 102 issues an instruction to the wiper control unit 106 or defroster control unit 109 in accordance with the status obtained, referring to FIG. 34. The wiper is controlled in speed at three steps, high, intermediate, and low. The defroster is controlled to blow or not to blow hot air at the maximal amount to the inner surface of the windshield 105.

The above embodiment has described an example where the image sensor 206 is configured to receive the specular reflection L3 by the outer surface of the windshield 105 with no raindrops attached but not to receive the reflection L2 incident on the raindrops on the windshield. Alternatively, the image sensor 206 can be configured to receive a reflection by the raindrops and not to receive a specular reflection by the outer surface of the windshield 105 with no raindrops. Furthermore, a mirror element with the reflective surface 21 can be used for the optical element instead of the reflection/deflection prism 220.

According to the present embodiment, the optical element forms an optical path to return the reflection by the attached matter on the outer surface of the windshield to the light source. With such an optical element, the imaging element can be disposed close to the light source. This makes it easier to downsize the imaging unit including the imaging element and light source.

Further, the optical element is configured to have the light through the transmissive surface totally reflected by the outer surface of the windshield only once and emit it from the exit surface. This can leads to downsizing both the optical element and the imaging unit and reducing optical loss, compared to one requiring plural total reflections.

Owing to the refraction by either the incidence surface or the exit surface of the optical element at a certain refraction angle, the optical element and the imaging unit can be easily downsized.

Further, owing to the rotational coupling mechanism 240 as positioning mechanism, the certain refraction angle can be easily adjusted.

According to the present embodiment, in installing the imaging unit, the first and second modules are rotatably coupled by the rotational coupling mechanism to limit the relative position of the two modules. Therefore, the relative position thereof can be easily adjusted.

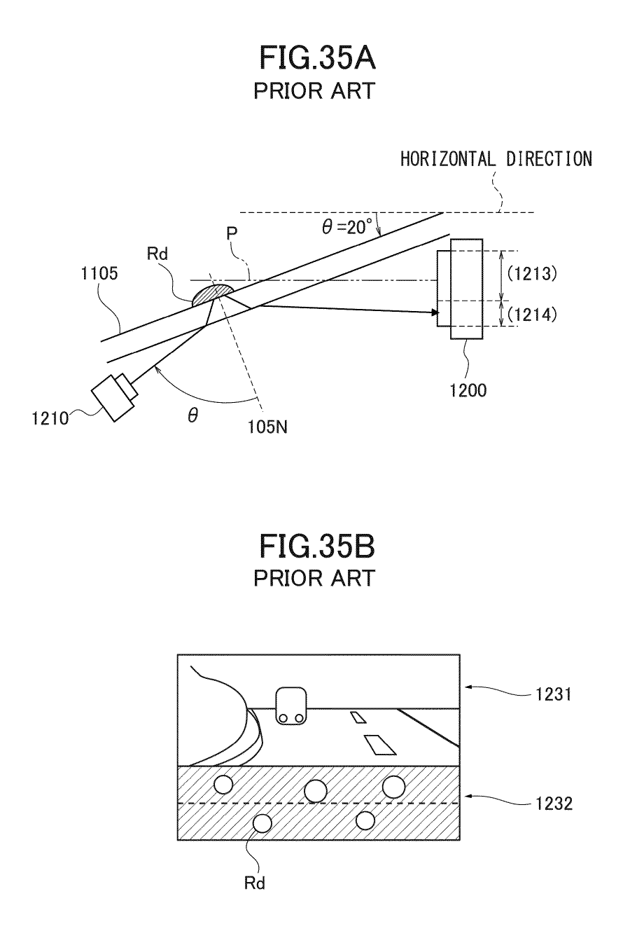

In the related-art imaging unit in FIG. 35A, the position of the light source 1210 relative to the imaging element 1200 and the light emitting direction of the light source 1210 are unchanged. Therefore, the imaging unit can be installed easily by placing it so that the imaging element 1200 captures an image in a certain direction P, if the inclination angle θg of the windshield is preset. However, since the inclination angle θg is different depending on a vehicle type, the unit of the imaging element 1200 and light source 1210 can be applied only for a limited type of vehicle.

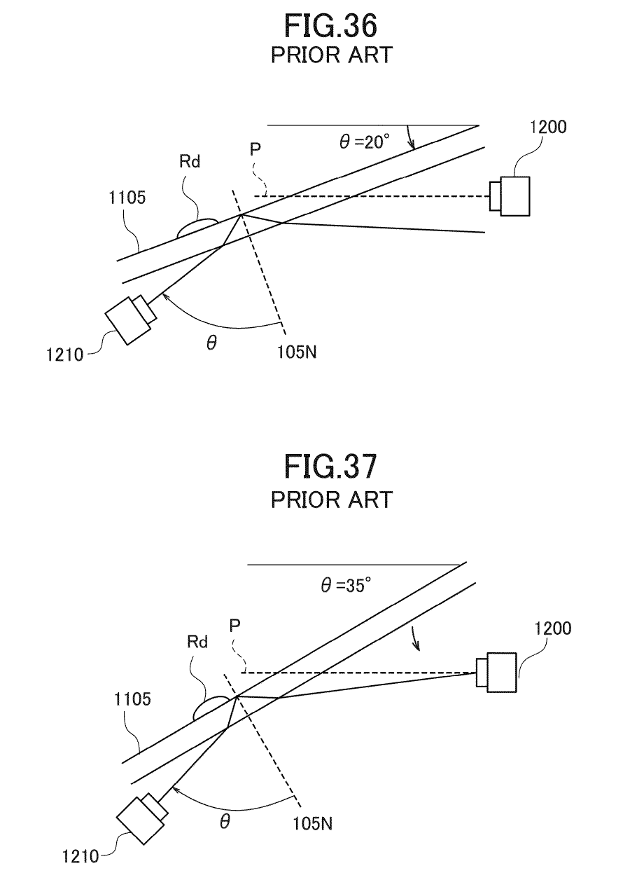

FIG. 36 shows the optical path from the light source reflected by the outer surface of the windshield 1105 when an imaging unit optimized for the windshield inclined at 20 degrees is installed for that 1105 inclined at 20 degrees. FIG. 37 shows the same when the same imaging unit is installed for that 1105 inclined at 35 degrees. A part of the light projected from the light source 1210 is reflected by the internal or outer surface of the windshield 1105. The specular reflection by the outer surface with high intensity is displayed on the image area 1232 for attached matter detection as ambient light, deteriorating the accuracy with which the raindrops Rd are detected. Thus, the angle of the light source 1210 needs to be adjusted to display the light reflected by the raindrops Rd in FIG. 35A but not to display the specular reflection by the outer surface of the windshield 1105 on the image area 1232.

The imaging unit in FIG. 36 can be installed simply for the windshield inclined at 20 degrees by placing it so that the imaging element 1200 captures images in a certain direction, so as to prevent the specular reflection by the outer surface from entering the imaging element 1200. Therefore, it can capture the images ahead of the vehicle in the image area 1231 for vehicle detection of the imaging element 1200 as well as the raindrops images in the image area 1232 for attached matter detection without noises by the specular reflection. However, with this imaging unit installed on a vehicle windshield inclined at over 20 degrees, the incidence angle of the light from the light source 1210 on the internal surface of the windshield 1105 is larger than that when the inclination angle of the windshield 1105 is 20 degrees. As a result, the specular reflection by the outer surface of the windshield 1105 travels more upward than that in FIG. 36 and enters the imaging element 1200.

Next, there is another type of an imaging unit in which the certain direction P of the imaging element 1200 is adjustable with the light source 1210 fixed on the internal surface of the windshield 1105. The installment of the imaging unit is completed simply by adjusting the angle of the imaging element 1200 and fixating the light source 1210 on the internal surface, so as to prevent the specular reflection by the outer surface from entering the imaging element 1200. With this imaging unit installed on a vehicle windshield inclined at over 20 degrees, the incidence angle θ of the light from the light source 1210 on the internal surface of the windshield 1105 is the same as that when the inclination angle of the windshield 1105 is 20 degrees.

However, this imaging unit has a problem that the light emitting direction of the light source 1210 changes in accordance with the inclination angle θg of the windshield 1105. With a change in the inclination angle θg, the traveling direction of the specular reflection by the outer surface is shifted even at the same incidence angle θ. For example, if the imaging unit is installed on the windshield 1105 inclined at 35 degrees in FIG. 37, the direction of the specular reflection is shifted upward by 15 degrees as a difference in the inclination angles from FIG. 36. As a result, the specular reflection is incident on the imaging element 1200.

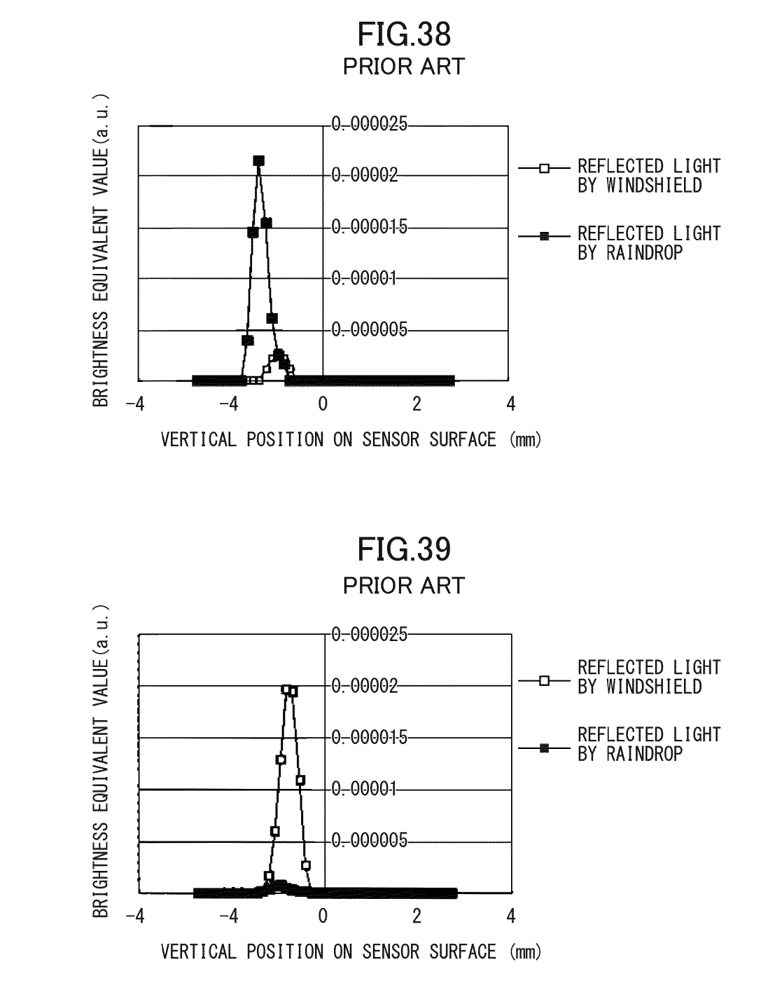

FIG. 38 is a graph showing the amounts of light reflected by the raindrops and the windshield and received by the imaging element 1200 when the specular reflection by the outer surface of the windshield 1105 is not incident on the imaging element 1200. FIG. 39 is a graph showing the same when the specular reflection by the outer surface of the windshield 1105 is incident on the imaging element 1200. In FIG. 38 the imaging element 1200 receives only a part of diffuse reflection by the internal and outer surfaces of the windshield 1105 and the amount thereof is much less than the amount of light reflected by the raindrops. Thus, for detecting raindrops, a high S/N ratio can be obtained. Meanwhile, in FIG. 39 the imaging element 1200 receives the specular light with a high intensity as ambient light and the amount thereof is larger than that of the light reflected by the raindrops. Accordingly, a high S/N ratio cannot be obtained for detecting the raindrops.

A high S/N ratio can be acquired to maintain the raindrops detection accuracy as long as the specular reflection by the windshield does not enter the imaging element 1200 even at the inclination angle θg being not 20 degrees. However, in reality the inclination angle range of the windshield 1105 in which the specular light is prevented from entering the imaging element 1200 is very narrow due to the fact that the light from the light source is divergent generally. Because of this, a problem arises that the above-described, installation—easy imaging unit cannot be applied to various windshields in a wide range of inclination angles. Although it is possible to apply the imaging unit to those windshields at different inclination angles by adjusting the position and light emitting direction of the light source 1210 in addition to the angle of the imaging element 1200, it requires additional works for the adjustments of the light source 1210, which hinders the simple installation of the imaging unit.

The above problems similarly occur if the imaging element receives the specular reflection not by raindrops but by the non-attached matter area on the outer surface area. The imaging element is similarly required not to receive the specular reflection by the non-attached matter area.

Also, the above problems occur if the imaging element captures the raindrops but does not capture the vehicle anterior area. It is difficult to mount the imaging element on the inner surface of the windshield, and it is generally attached to a cabin ceiling or a rearview mirror. The inclination angle of the windshield differs depending on a vehicle type. In a different vehicle the place or posture in which the imaging element is mounted is changed. Thus, a relation between the light source mounted on the windshield and the imaging element changes according to the inclination angle of the windshield.

According to the present embodiment, the posture of the first module supporting the optical element changes in accordance with the inclination angle of the windshield, however, that of the second module is independent of the inclination angle and determined by another condition. The light source supported by the second module emits light in a direction irrespective of the inclination angle while the orientation of the reflective surface of the optical element changes in accordance with the inclination angle of the windshield. With a change in the inclination angle, the incidence angle of the light from the light source on the reflective surface changes. However, the rotational coupling mechanism is configured that the imaging element can stably receive the specular reflection by the non-attached matter area on the outer surface of the windshield among the specular reflection by the reflective surface of the optical element irrespective of a change in the inclination angle as long as the relative angle of the first and second modules falls within a pre-defined range of angles.

With use of the imaging element receiving specular reflection not by the outer surface of the windshield but by the raindrops, the rotational coupling mechanism is configured that as long as the relative angle of the first and second modules falls within a pre-defined range of angles, the imaging element can stably receive the specular reflection L3 by the attached matter on the outer surface of the windshield among the specular reflection L2 and attached matter can be stably detected irrespective of the inclination angle of the windshield.

Moreover, since the second module is comprised of the components of the light source and those of the imaging element mounted on the same substrate. This accordingly reduces the number of substrates and costs.

In the present embodiment the light receiving surface of the imaging element is divided into the first image area for vehicle detection and the second image area for attached matter detection. Thereby, the attached matter can be detected using the imaging element capturing the imaging area.

Owing to the spectral filters, the imaging unit can reduce the amount of ambient light and improve the attached matter detection accuracy.

Using the reflection/deflection prism 220, the optical element can be realized at low costs.

Due to the optical element comprising the concave reflective surface, diffuse light beams incident on the reflective surface can be parallelized, which can prevent a decrease in the luminance on the windshield.

Further, the attached matter detector incorporating the downsized imaging unit as above can detect the attached matter on the outer surface of the windshield.

Further, the control system for a vehicle including the downsized imaging unit as above and the vehicle including such a control system can detect attached matter on the outer surface of the vehicle windshield and control the units of the vehicle.

Although the present invention has been described in terms of exemplary embodiments, it is not limited thereto. It should be appreciated that variations or modifications may be made in the embodiments described by persons skilled in the art without departing from the scope of the present invention as defined by the following claims.

1. An imaging unit comprising:
a light source placed on one surface of a light transmissive plate-like element to project a light to the one surface of the plate-like element;
an imaging element to capture an image of an attached matter on the other surface of the plate-like element illuminated with the light from the light source; and
an optical element having an incidence surface on which the light is incident from the light source, a reflective surface by which the light incident from the incidence surface is reflected, a transmissive surface contacting the one surface of the plate-like element, through which the light reflected by the reflective surface transmits, and an exit surface from which the light transmitting through the transmissive surface and reflected by the other surface of the plate-like element is emitted towards the imaging element.

2. An imaging unit according to claim 1, wherein
the optical element is adapted to allow the light to transmit through the transmissive surface, be totally reflected by the other surface of the plate-like element only once and emitted from the exit surface to the imaging element; and
the imaging element is adapted so that a top end of the imaging element is located above a top end of the optical element, to be able to image an area not including the optical element.

3. An imaging unit according to either claim 1, wherein
the optical element is adapted to refract the light from the light source at a certain refraction angle by at least either of the incidence surface and the exit surface; and
the imaging element is adapted so that a top end of the imaging element is located above a top end of the optical element, to be able to image an area not including the optical element.

4. An imaging unit according to claim 3, further comprising:
a first support to fixedly support the optical element on the one surface of the plate-like element;
a second support to fixedly support the light source and the imaging element; and
a positioning mechanism to relatively position the first and second supports to attain the certain refraction angle, wherein
the optical element is adapted to refract the light from the light source at a certain refraction angle by at least either of the incidence surface and the exit surface.

5. An imaging unit according to claim 4, wherein
the positioning mechanism is a rotational coupling mechanism with a rotational shaft orthogonal to an incidence plane of the light reflected by the reflective surface of the optical element relative to the one surface of the plate-like element, to couple the first and second supports to be relatively rotatable around the rotational shaft.

6. An imaging unit according to claim 5, further comprising
a positioner for the first support to position the optical element on the one surface of the plate-like element so that the imaging element receives, among the light projected from the light source and specularly reflected by the reflective surface of the optical element, the light specularly reflected by a non-attached matter area or the light specularly reflected by the attached matter on the other surface of the plate-like element, as long as a relative angle of the first and second supports falls within a pre-defined range.

7. An imaging unit according to claim 6, wherein
the positioner for the first support is configured to maintain, in a certain range, a relative angle between the optical axis of the light from the light source and the optical axis of the light specularly reflected by the non-attached matter area or reflected by the attached matter on the other surface and received by the imaging element, as long as the relative angle of the first and second supports falls within the pre-defined range.

8. An imaging unit according to claim 6, wherein
the rotational coupling mechanism is configured to maintain, in a pre-defined area, a position at which the imaging element receives the light specularly reflected by the not-attached matter area or the attached matter on the other surface of the plate-like element, as long as the relative angle of the first and second supports falls within the pre-defined range.

9. An imaging unit according to claim 4,
wherein the second support includes a single substrate on which components of the light source and components of the imaging element are mounted.

10. An imaging unit according to claim 1, wherein a light-receiving surface of the imaging element is divided into a first image area in which a light incident from a predetermined imaging area and transmitting through the other surface of the plate-like element is received to capture an image of the predetermined imaging area and a second image area in which an image of the attached matter is captured.

11. An imaging unit according to claim 1, wherein the imaging element comprises a spectral filter to selectively transmit a wavelength range of the light from the light source.

12. An imaging unit according to claim 1,
wherein the optical element is a prism.

13. An imaging unit according to claim 1,
wherein the reflective surface of the optical element is a concave surface.

14. An attached matter detecting device comprising:
the imaging unit according to claim 1; and
an attached matter detector to detect an attached matter on the other surface of the plate-like element according to an image captured by the imaging unit.

15. A control system for a vehicle having a plate-like window and an imaging unit having an imaging element mounted on an inner surface of the plate-like window to capture an image of an attached matter on the outer surface of the plate-like window, comprising:
an attached matter detector to detect an attached matter on the outer surface of the plate-like window according to an image captured by the imaging unit; and
a controller to control units of the vehicle according to a result of the detection by the attached matter detector.

16. A vehicle having a plate-like window, comprising the control system according to claim 15 to control the units of the vehicle.
